(19) United States
(12) Patent Application Publication
(10) Pub. No.: US 2003/0120577 A1
(43) Pub. Date: Jun. 26, 2003

(54) Business performance index processing system

(76) Inventors: Hiroshi Sakui, Abiko (JP); Hiroyuki Yagi, Tokorozawa (JP); Genichiro Ichihari, Tokyo (JP); Yuichi Ikeda, Mito (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/307,934

(22) Filed: Dec. 3, 2002

(30) Foreign Application Priority Data
Dec. 3, 2001 (JP) 2001-369083

(51) Int. Cl. G06F 17/60

(52) U.S. Cl. 705/36

(57) ABSTRACT

A computer is used to perform the calculations for obtaining a capital composition corresponding to a predetermined default probability based on a probability distribution of a return on investment, a weighted average cost of capital based on the capital composition, a borrowing cost, and an equity cost, and a market efficiency value added from the weighted average cost of capital and a net operating profit after tax. The market efficiency value added obtained through these calculations is then displayed appropriately so as to provide support in decision-making.

### CROSS-REFERENCE TO RELATED APPLICATIONS

The present application relates to application Ser. No. 10/227,796, filed Aug. 27, 2002, entitled “BUSINESS PERFORMANCE INDEX PROCESSING SYSTEM”, by I. Genichiro, et al., the contents of which are incorporated herein by reference.

### BACKGROUND OF THE INVENTION

The present invention relates to a business performance index processing system. More particularly, it relates to displaying, through calculations performed by a computer for business performance-related indices and based on the results of these calculations, an item related to measurement of performance of an entire enterprise or business units the enterprise has therein, or a new business to be started.

In recent years, the business circumstances surrounding enterprises have become more and more severe and it has become important to even more properly evaluate each business of an enterprise and to appropriately evaluate the future of a new business planned so as to meet the requirement of both the stockholders (investors) and creditors.

Various performance measurement methods are currently examined and applied to making a business performance evaluation. Nonetheless even more appropriate displaying method is desired.

### SUMMARY OF THE INVENTION

An object of the present invention is to provide a business performance index processing system that performs calculations through an appropriate method for obtaining market efficiency value added (MEVA) that can be used as an index for evaluation of business performance and displays the results of the calculations.

Another object of the present invention is to provide a system capable of displaying appropriately a business value in a format that helps make a decision in terms of management of an enterprise.

Other objects of the present invention will be described in the preferred embodiments of the invention to be described later.

To achieve the foregoing objects, the business performance index processing system according to the preferred embodiments of the present invention performs calculations for obtaining the following three parameters based on a probability distribution of the ratio of the value of profit to the investment amount (ROI). The three parameters are: a capital composition (debt/equity ratio) that satisfies a predetermined default probability; a weighted average cost of capital based on the capital composition, and a borrowing cost and an equity cost; and, market efficiency value added, or MEVA, from the weighted average cost of capital based on a net operating profit after tax. Based on the results of these calculations, it thereby produces an output of an appropriate form, and gives a display, of indices that serve as the basis for making a managerial decision.

The invention is characterized in a number of aspects to be described in the preferred embodiments of the invention to be described later.

### BRIEF DESCRIPTION OF THE DRAWINGS

Other objects and advantages of the invention will become apparent from the following description of embodiments with reference to the accompanying drawings in which:

FIG. 1 is a system flowchart showing a business performance index processing system according to an embodiment of the present invention;

FIG. 2 is a diagram showing each combination of a rating, a default probability, and a borrowing cost;

FIG. 3 is a diagram used for calculating an equity risk;

FIG. 4 is a diagram used for calculating an equity cost (Re);

FIG. 5 is a diagram showing a business risk (ROI distribution);

FIG. 6 is a diagram showing a typical screen displaying a MEVA value for each fiscal year and a total of MEVA values;

FIG. 7 is a diagram showing a typical screen displaying an analysis of differences between forecast and record MEVA values;

FIG. 8 is a diagram showing a typical screen displaying a distribution of net operating profits after tax totaled for an entire period of a business plan of a specific business unit;

FIG. 9 is a diagram showing a typical screen displaying a list of major financial statements figures of all businesses;

FIG. 10 is a diagram showing a typical screen displaying the relationship between the MEVA and invested capital according to the business unit (to be invested);

FIG. 11 is a diagram showing a typical screen displaying risk and return values of each business and the entire enterprise, and an effective frontier curve depicting an efficient business composition;

FIGS. 12A and 12B are diagrams showing typical screens displayed when a cursor is aligned with the total of all businesses and each of the different businesses shown in FIG. 11, respectively;

FIG. 13 is a diagram showing a typical screen displaying percentage distribution of businesses on the effective frontier;

FIG. 14 is a diagram showing a typical screen displaying MEVA of each business and a marginal effect of the business in question on the entire enterprise (increased or decreased effect of MEVA), or Accumulated Discounted-MEVA;

FIG. 15 is a diagram showing a typical screen displaying an accumulated discounted value of MEVA of each business and an effect (marginal accumulated discounted value) of the business in question on the entire enterprise, or Marginal Accumulated Discounted-MEVA;

FIG. 16 is a block diagram showing a system configuration of a business performance index processing system according to an embodiment of the present invention;

FIG. 17 is a flowchart showing processing operations performed for calculating a borrowing cost in a business performance index processing system;

FIG. 18 is a flowchart showing processing operations performed for calculating MEVA in a business performance index processing system;

FIGS. 19A-D are diagrams showing graphs of the average and worst case scenarios of the future state of selected property and the average and worst case scenarios of the future of cash flow for a selected enterprise;

FIG. 20 is a flow chart of the operation of the system according to the present invention;

FIG. 21 is a system flowchart showing monthly performance and risk by business units;

FIG. 22 is a system flowchart showing monthly performance and risk on the entire business;

FIG. 23 is a graph showing monthly actual profit and its seasonally adjusted series by business unit, and monthly forecasted profit based on AR Analysis;

FIG. 24 is a graph showing monthly actual ROI and its seasonally adjusted series by business unit, and monthly forecast of ROI based on AR Analysis and MR Analysis;

FIG. 25 is a graph showing actual ROI and the risk (standard deviation) that MAPT analysis estimates;

FIG. 26 is a graph showing the achieve probability and the loss probability by business units;

FIG. 27 is a graph showing efficient frontier and each business unit position and present business portfolio position;

FIG. 28 is a graph showing the actual ROI and the expected ROI and WACC by business unit;

FIG. 29 is a graph showing influence (contribution value) that a macro index has on the profit of the entire business;

FIG. 30 is a graph showing present influence (exposure) that a macro index has on the profit of the entire business;

FIG. 31 is a graph showing past and present influence (exposure) that a macro index has on the profit of the entire business; and

FIG. 32 is a graph showing MEVA and influence that each business unit has on the portfolio (Marginal value).

### DESCRIPTION OF THE PREFERRED EMBODIMENTS

The calculations performed to obtain market efficiency value added, or MEVA, that serves as a business performance index and display thereof in the business performance index processing system according to the present invention may find applications in the following. Namely, it may be applicable to a value analysis, in which it is decided whether or not to invest in a new business to be started. It may also appropriately be applicable to determining whether or not an entire enterprise or a specific existing business unit is efficient or dynamic and revitalized enough.

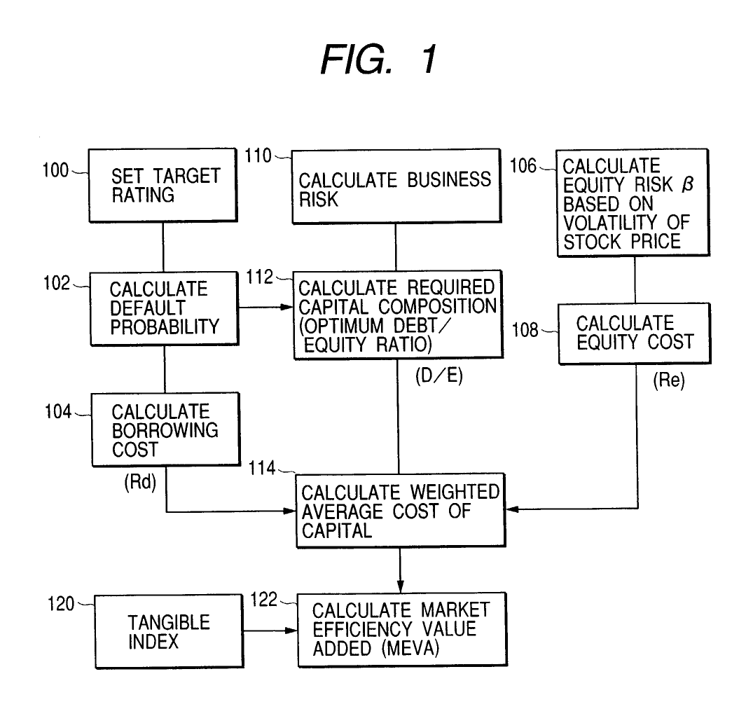

FIG. 1 is a flowchart of computer processing performed by a business performance index processing system according to an embodiment of the present invention.

The MEVA is calculated as follows. It is calculated by subtracting a cost of capital invested in a business from a profit earned by the business. Namely, it is expressed as:

Market Efficiency Value Added=Net Operating Profit after Tax−Cost of Capita (1)

The net operating profit after tax is a net profit before interest after tax as calculated according to accounting rules.

The cost of capital is calculated as described below. The invested capital is, to begin with, expressed as:

Invested Capital=Debt+Equity (2)

The invested capital is therefore the sum of a fund (debt) raised as the money borrowed from financial institutions or the like and issued bonds, and a fund (equity) raised as the capital stock obtained as a result of issuing stocks or the like and retained earnings or the like. It represents a fund that is needed to set up and carry out the business. Further, it is necessary to pay a source of the fund the cost that corresponds with the business, that is, the cost of capital. The ratio of the cost of capital to the invested capital is the weighted average cost of capital. Namely, it is expressed as:

Cost of Capital=Weighted Average Cost of Capital×Invested Capital (3)

The cost of capital may be divided into a portion involved with debt and a portion involved with equity. Namely, it is expressed as:

Cost of Capital=Borrowing Cost×Debt+Equity Cost×Equity (4)

The borrowing cost refers to an interest rate of borrowings, and the equity cost refers to an expected return on equity demanded by stockholders, such as dividends paid to stockholders or an increase in retained earnings. The weighted average cost of capital may be expressed by dividing each of both sides of (4) by the invested capital. Namely, it is expressed as:

Weighted Average Cost of Capital=Borrowing Cost×(Debt/Invested Capital)+Equity Cost×(Equity/Invested Capital) (5)

The weighted average cost of capital can be calculated by obtaining a weighted average of the borrowing cost and the equity cost in terms of the capital composition.

When the weighted average cost of capital is calculated and the cost of capital can be obtained, it then becomes possible to calculate MEVA using equation (1).

From the viewpoint of an entire enterprise, the borrowing cost and an equity ratio are determined efficiently in the market, which allows the cost of capital to be calculated relatively easily.

Assume, on the other hand, that it is attempted to calculate the cost of capital of each business unit within an enterprise. The capital invested in a specific business unit represents a share of the total invested capital appropriated for that particular business unit out of the total invested capital of the enterprise. The weighted average cost of capital of each individual business unit is therefore not constant. The following method is therefore employed to virtually divide the invested capital for each business unit into debt and equity, thereby obtaining the weighted average cost of capital of each. This weighted average cost of capital is then used to arrive at the cost of capital.

Referring to FIG. 1, the borrowing cost is first calculated.

Calculation of the borrowing cost proceeds as follows. First of all, default probability and borrowing cost values associated with different credit ratings are established as shown in FIG. 3 using a database that stores therein past default records, actual market standings, and the like. When a target rating of the business unit to be evaluated is set in step 100, the default probability of the business unit concerned is determined in step 102, and the borrowing cost (Rd) of the business unit concerned is determined in step 104.

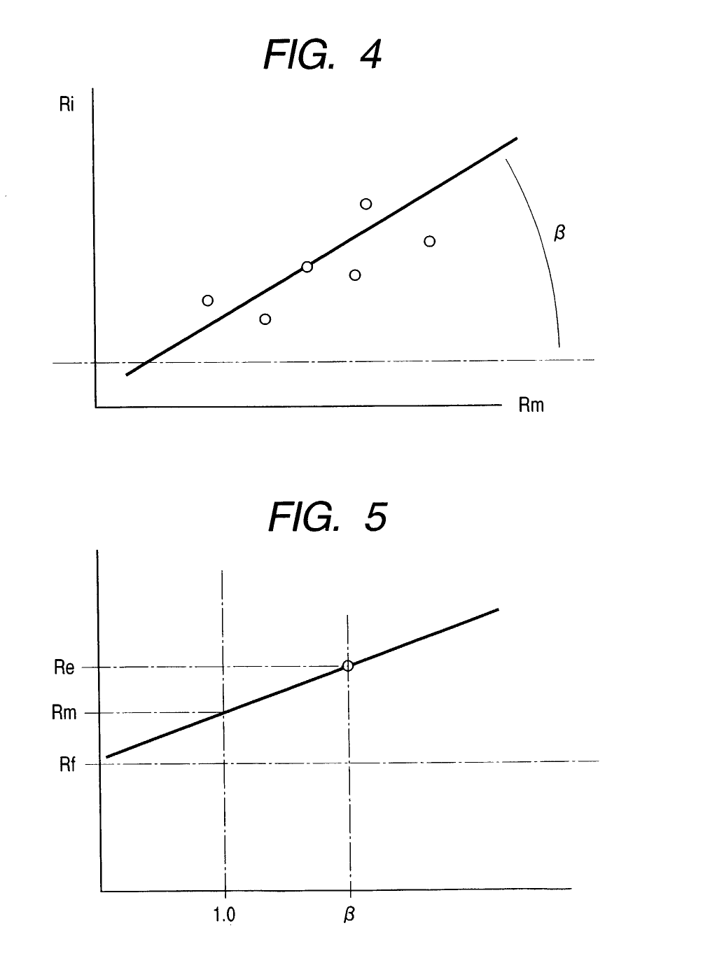

Calculation-of the equity cost of the business unit concerned is then performed. The equity cost represents the cost for the equity (dividends to be paid to stockholders or an increase in retained earnings). Calculation of the equity cost (Re) proceeds as follows. In step 106, an equity risk index β is calculated using past data of the return of the target enterprise (Ri) (or the per share earning ratio of a company in the same industry, if the target enterprise is not listed) and the return of a stock market (Rm) (for example, TOPIX), as shown in FIG. 4. The equity risk index β can be obtained using the following equation:

β=(covariance between the stock price and TOPIX)/(variance of TOPIX) (6)

The equity cost (Re) is then calculated in step 108. The equity cost (Re) is obtained from a diagram, as shown in FIG. 5, in which the horizontal axis represents values of the equity risk index β, while the vertical axis represents the return (R). Referring to FIG. 5, assume that the per share earning ratio of the stock market (for example, TOPIX) is Rm when the equity risk index β is 1.0. Assume also that a rate of return on risk-free assets such as sovereign bonds is Rf. The per share earning ratio when the equity risk index obtained in FIG. 4 is β is the equity cost (Re).

Using a capital asset pricing model (CAPM) and the equation given in the following, the equity cost (Re) is therefore calculated from Rf and Rm:

Re=Rf+β×(Rm−Rf) (7)

Calculation for the required capital composition (an optimum debt/equity ratio) is next performed. It is obtained from the default probability (e.g., 0.1%) determined in step 102 and a business risk. The business risk can be represented by a stochastic distribution of the ratio (ROI, or Return on Investment) of the value of profit (operating profit) to the invested capital (the invested amount of money).

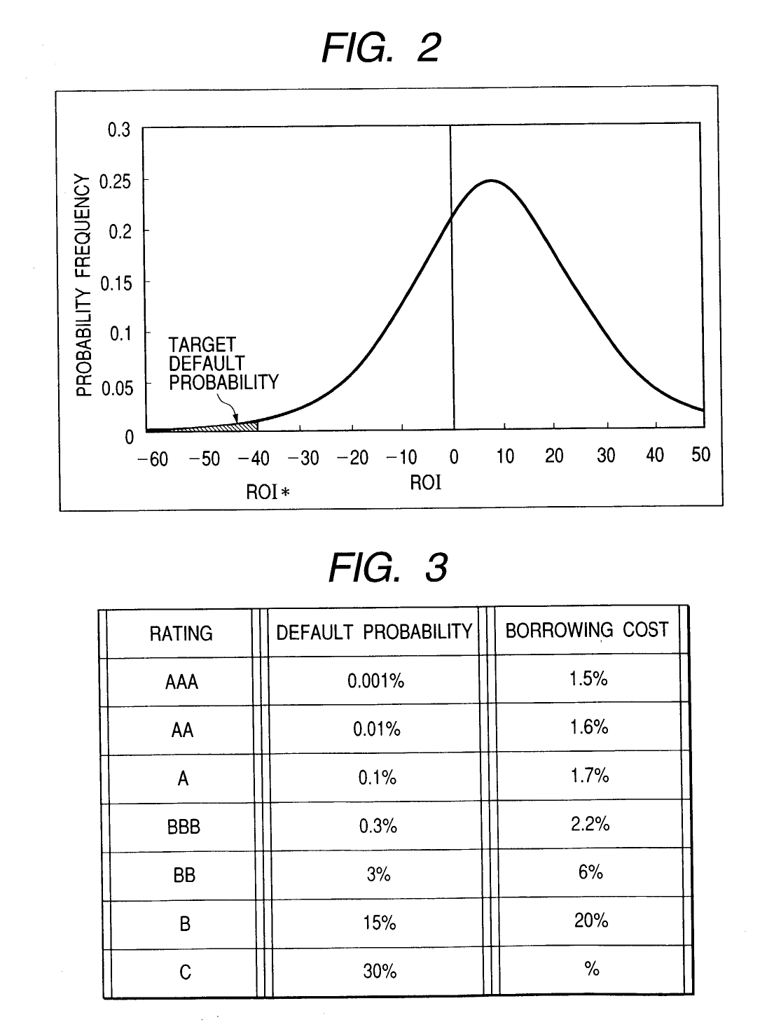

Reference is now made to FIG. 2, in which the horizontal axis represents ROI values (%) and the vertical axis represents a probability frequency. In the graph (showing an ROI distribution curve) shown in FIG. 2, a specific ROI value is identified according to the default probability (e.g., 0.1%) and the capital composition (the debt/equity ratio) corresponding to the identified ROI value is obtained. This capital composition (the debt/equity ratio) therefore fluctuates depending on the business risk (ROI distribution) and a set target credit rating (that is, the default probability).

The following description elaborates on it. In the ROI distribution curve shown in FIG. 2, assume that the entire area defined by the ROI distribution curve is 1. Focusing only on an extreme end of the negative ROT value as data of immediate concern allows to find the ROT distribution point, at which the area of the chart is 0.1%. The area of chart of 0.1% indicates that there is an only 0.1% probability of a loss increasing than this. The ROT value corresponding to the area of 0.1% may be, for example, −40%. This means that, for an enterprise (business) having an ROT distribution as shown in FIG. 2, the equity accounts for 40% of the invested capital (debt+equity). It therefore follows that, for an enterprise (business) having an ROT distribution curve as shown in FIG. 2, it is necessary that the equity accounts for 40% of the invested capital in order to set the default probability at 0.1%.

The required capital composition (an optimum debt/equity ratio) and the weighted average cost of capital are calculated as described in the foregoing. In step 120, the net operating profit after tax is obtained according to accounting rules. In step 122, the MEVA is calculated as detailed below using the weighted average cost of capital calculated in step 114.

Market Efficiency Value Added (MEVA)=(Net Operating Profit after Tax/Invested Capital−Weighted Average Cost of Capital)×Invested Capital (8)

In the process of obtaining the weighted average cost of capital, consideration has been given to maintaining consistency between the bond market and the stock market in regard to the borrowing cost, equity cost, and the debt/equity ratio. This makes it possible to calculate a market efficiency business value.

In step 124, a Marginal Accumulated Discounted-MEVA, or MAD-MEVA, is calculated in order to measure a marginal effect of an individual business in an enterprise-wide portfolio.

When calculating an Accumulated Discounted-MEVA, or AD-MEVA, an adjustment is made using a “risk-free rate” or the “weighted average cost of capital” before adding up MEVA values between different points in time. Specifically,

AD-MEVA=Σ{MEVAt/(1+r)t−s}

where, t: period to be evaluated; s: reference period for evaluation; MEVAt: MEVA record for period t; r: risk-free rate (government bond rate or the like) or weighted average cost of capital.

The following concept is applied to the measurement method of the marginal effect. Assuming a business portfolio X comprising three businesses of A, B, and C, each MEVA can be expressed as follows based on equation (1).

MEVA A=Net Operating Profit after Tax A−Cost of Capital A

MEVA B=Net Operating Profit after Tax B−Cost of Capital B

MEVA C=Net Operating Profit after Tax C−Cost of Capital C

MEVA X=Net Operating Profit after Tax X−Cost of Capital X

The following relationship holds true between the net operating profit after tax of each individual business and the net operating profit after tax of the business portfolio.

Net Operating Profit after Tax X=Net Operating Profit after Tax A+Net Operating Profit after Tax B+Net Operating Profit after Tax C (9)

The relationship between each business and the business portfolio is as follows in terms of the cost of capital.

Cost of Capital X=Cost of Capital A+Cost of Capital B+Cost of Capital C (10)

Since it can be expected that a business risk forming part of the cost of capital is reduced by the effect of diversification of portfolio, the cost of capital of the business portfolio can be eventually smaller. From equations (9) and (10), the following relationship therefore holds true between each individual business and the business portfolio in terms of MEVA.

MEVA X≧MEVA A+MEVA B+MEVA C (11)

Specifically, as the number of businesses that make up the business portfolio increases, it becomes more likely that the MEVA of the entire business portfolio is greater than the simple addition of MEVA values involved with individual businesses. An effective business portfolio management can therefore be implemented by comparatively examining the MEVA value of each individual business and the difference in MEVA values between the MEVA value before and that after the business in question is added (marginal MEVA).

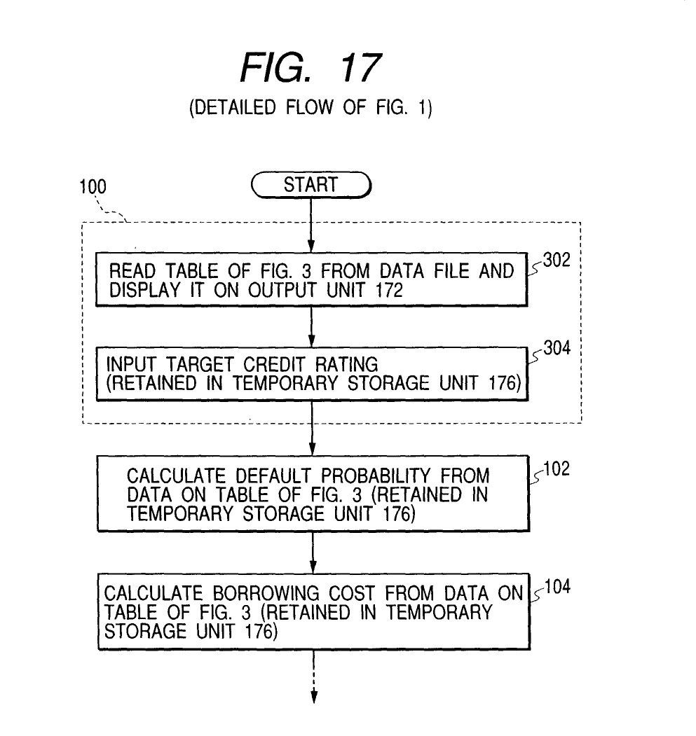

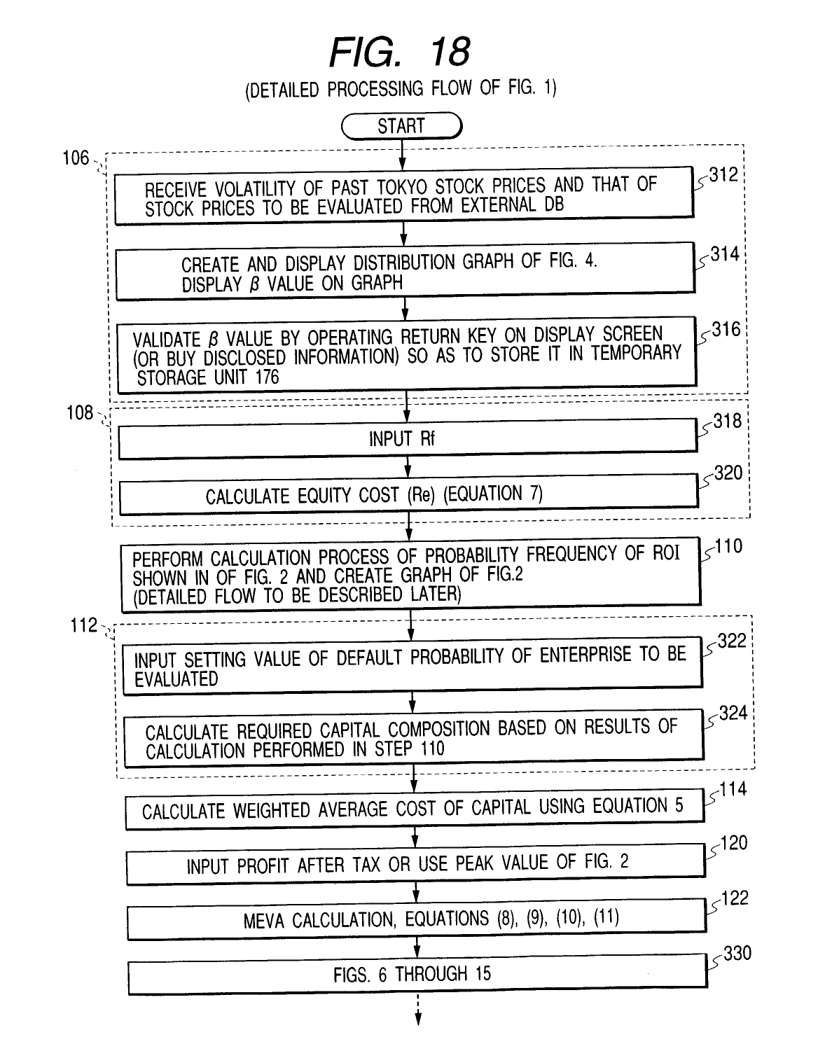

The system and processing operations thereof will be described with reference to the system configuration diagram for implementing a business performance index processing system shown in FIG. 16 and detailed flowcharts shown in FIGS. 17 and 18.

The system shown in FIG. 16 is what is called a computer system, comprising an input unit 170, an output unit 172, a processing unit 174, a temporary storage unit 176, a transmitter/receiver unit 178, and a storage unit storing various types of data files 180 to 188, all connected to a bus 192.

The input unit 170 is an input means of a known personal computer, or PC, provided with keys for data entry or a mouse. It may further include a reader for a recording medium such as a CD. The output unit 172 is a display device of the PC and a printer. The processing unit 174 may be a processor of the PC or that of a server. The temporary storage unit 176 is a main memory of the PC or a server. This system may be connected by way of the transmitter/receiver unit 178 to an external computer system through a public network such as the Internet.

The data file 180 stores therein a table of credit ratings relating to corresponding default probability and borrowing cost values shown in FIG. 3. This table is generally created as follows. Namely, credit rating data and default probability data which are disclosed by credit-rating firms are purchased and input through the input unit 170. The borrowing cost data is purchased from banks in a form created by the banks and input through the input unit 170. The processing unit 174 edits and processes the data input through the input unit 170 and the resultant processed data is stored in memory as the data file 180.

The data file 182 stores therein stock price data. The data file 184 stores data on ROI/probability distribution shown in FIG. 2. The data file 186 stores files of ROI. The data file 188 stores the business management data.

Processing for calculation of the borrowing cost shown in FIG. 1 will be described with reference to FIG. 17. The tabulated data of FIG. 3 is read from the data file 180 for setting of credit rating and displayed on the output unit 172 (302). The credit rating is then input through the input unit 170. It is temporarily stored in the temporary storage unit 176 (304). The processing unit 174 next calculates the default probability from the tabulated data of FIG. 3. The result thereof is temporarily retained in the temporary storage unit 176 (102). The processing unit 174 then calculates the borrowing cost from the tabulated data of FIG. 3.

Calculation of the market efficiency value added (MEVA) will be described with reference to FIG. 18. To calculate the equity risk β from volatility of the stock prices (step 106), volatility of past Tokyo stock prices and that of the stock prices to be evaluated are obtained from an external database through the transmitter/receiver unit 178 (312). While this data is stored in the data file 182, the processing unit 174 not only creates the distribution graph shown in FIG. 4 to display it on the output unit 172, but also displays the P value plotted on the graph (314). The P value plotted on the graph is validated by operating a return key on the display screen. This value is stored in the temporary storage unit 176. For the calculation of the equity cost (step 108), the processing unit 174 calculates the equity cost (Re) (320) after Rf has been input (318).

For the calculation of the business risk, the processing unit 174 calculates the ROI probability distribution shown in FIG. 2 using the historical method or the simulation method, and creates the graph of FIG. 2 (110).

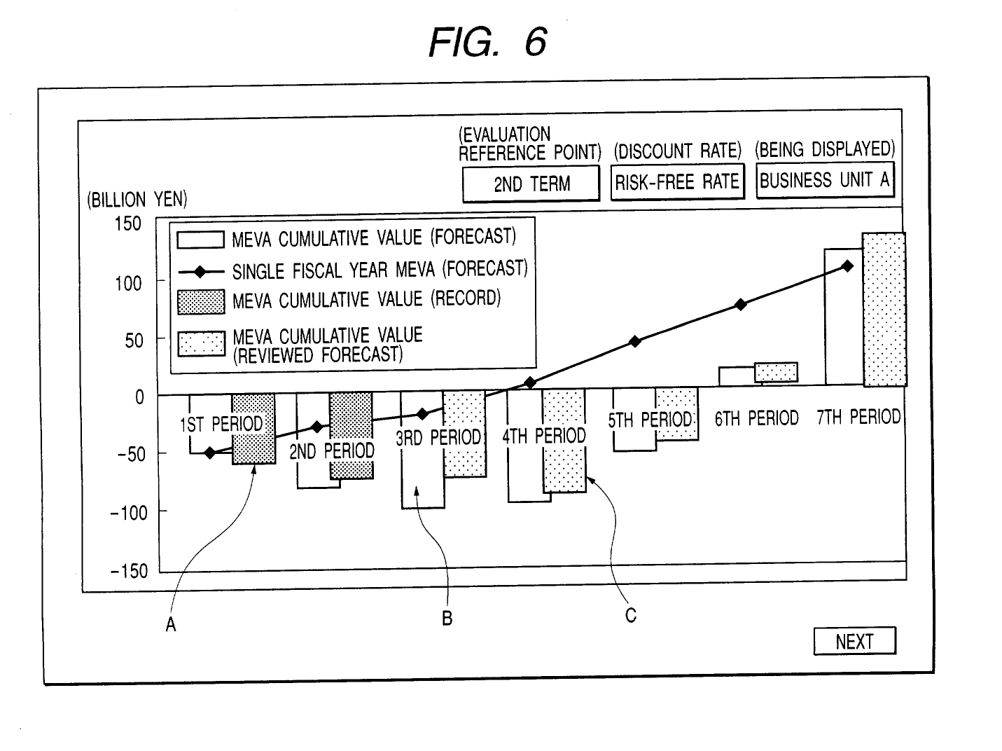

For the calculation of the required capital composition (112), when a setting value for the default probability of the enterprise to be evaluated is entered through the input unit 170 (322), the processing unit 174 calculates the required capital composition based on the result of calculation of the business risk (110) and the default probability (102). The processing unit 174 then calculates the weighted average cost of capital according to equation (5) (114). The unit 174 further calculates MEVA using data of profit after tax acquired from the data file 188 or a tangible index such as the peak value shown in FIG. 2 entered (120). This calculation is performed in accordance with equations (8), (9), (10), and (11) (Step 122). The processing unit 174 creates the graph shown in FIG. 6 and subsequent ones to show the result of the calculations performed and makes the display device of the output unit 172 display it.

The results of the calculations performed by the processing unit 174 are temporarily stored in the temporary storage unit 176 at different stages in the middle of calculation processes before the output is provided for the display. Those who are involved with a business performance evaluation make an investment decision by studying the graph that is displayed.

Displays of various kinds concerning MEVA will be described. MEVA for a single fiscal year and cumulative MEVA for each year for each business unit are displayed as shown in FIG. 6. The line graph shown in FIG. 6 represents numeric values of MEVA of each single fiscal year, while the bar graph shown in FIG. 6 represents the cumulative value thereof. Displaying both the line graph showing changes in the value of single fiscal year and the bar graph showing changes in the cumulative value makes it possible to even more appropriately identify performance of the business unit concerned. When more periods elapse to allow actual values of MEVA to be measured, it becomes possible to display in a bar graph the record values or cumulative values thereof in comparison with the original forecast values or cumulative values thereof.

In this display of MEVA, a specific business unit, for which the displayed data is intended, can be selected by dropping down a key marked with “Business Unit A” being displayed in the display shown in FIG. 6. The discount rate applicable to aggregating can also be selected by dropping down a key for the discount rate and selecting, for example, “risk-free rate.” The reference point for evaluation is also selectable by dropping down a key for the evaluation reference point in FIG. 6 and selecting, for example, the “2nd Period.”

Segment of data in the display of MEVA may also be selectively displayed, either individually for the total of all businesses, each business unit (business A, business B, business C, . . . ), and for each project to be invested (project a, project b, project c, . . . ), or collectively for comparison among a plurality of segments.

The calculation period for MEVA may be annual, semiannual, quarterly, or monthly and the display can be given for each period of calculation basis.

Clicking each bar of the bar graph shown in FIG. 6 will display data as shown below. Specifically, clicking the bar for the third period marked with B will display the following:

a) MEVA for the third period: X billion yen

b) Cumulative MEVA up to the third period: X billion yen (breakdown: plus X billion yen, minus X billion yen)

c) Expected cumulative MEVA for the fourth and subsequent periods: X billion yen (breakdown: plus X billion yen, minus X billion yen).

A display example shown in FIG. 6 is used by those who make an investment decision and those who formulate an investment plan when they attempt to measure the business value of the investment plan in question and use as bases for making a decision as to whether or not to invest in the business. As time elapses after the investment plan has been formulated to allow actual values to be measured, FIG. 6 may also be used for comparison and verification against the forecast values projected when the plan was first formulated.

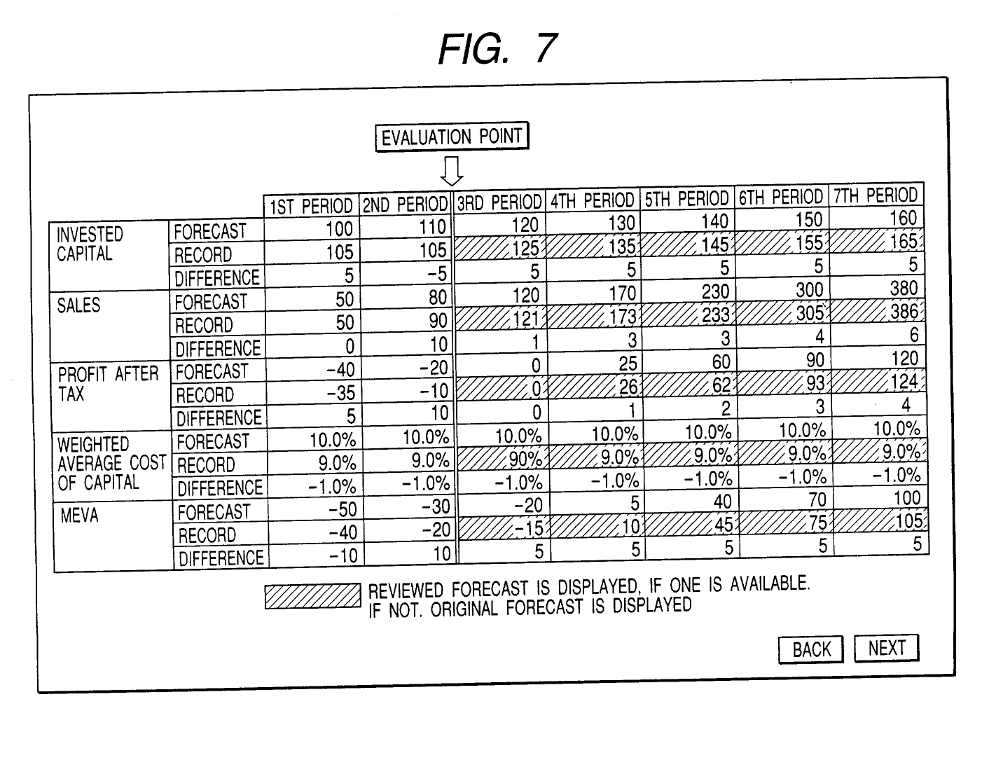

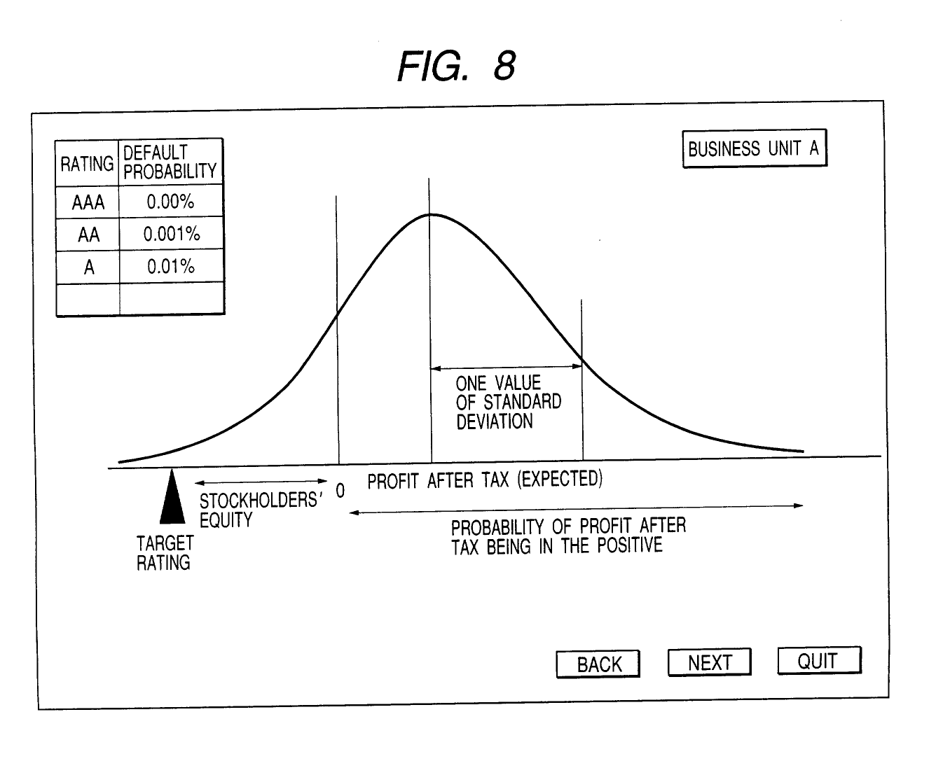

If any of the record values shown in FIG. 6, for example, A is clicked, it will display a screen that makes an analysis of differences from the forecast values (FIG. 7). Specifically, FIG. 7 displays a comparison between the forecast and record values of MEVA, and a verification and deviation analysis between the two. In more specific terms, the forecast and record values of MEVA shown in FIG. 6 are tabulated according to the period. In addition, FIG. 7 also gives data for the invested capital, sales, net operating profit after tax, and weighted average cost of capital that are required when calculating the MEVA in question. It displays the forecast and record values side by side and gives a difference between the two for each of these parameters, thus allowing a difference analysis for each to be made easily.

Furthermore, if the plan is reviewed at the time of evaluation, it is possible to display in the screen shown in FIG. 7 reviewed forecast values in the record value column after evaluation (for example, at the end of the second period). This makes it possible to identify the situation as immediately near as possible.

Clicking [Back] in the display screen shown in FIG. 7 will cause the screen shown in FIG. 6 to reappear. Clicking [Next] in the screen shown in FIG. 7 will show the screen shown in FIG. 8.

FIG. 8 shows a screen that displays a business risk of a particular business unit. Specifically, the horizontal axis represents the net operating profit after tax, while the vertical axis represents frequencies of corresponding values of the net operating profit after tax occurring. FIG. 8 is a diagram showing distribution of net operating profit after tax values tallied up for the entire period of a business plan for business unit A. The specific business, for which data is to be displayed, may nonetheless be selected by dropping down the box of the business unit name. The data may also cover a specific business plan or an entire enterprise, in addition to the specific business unit.

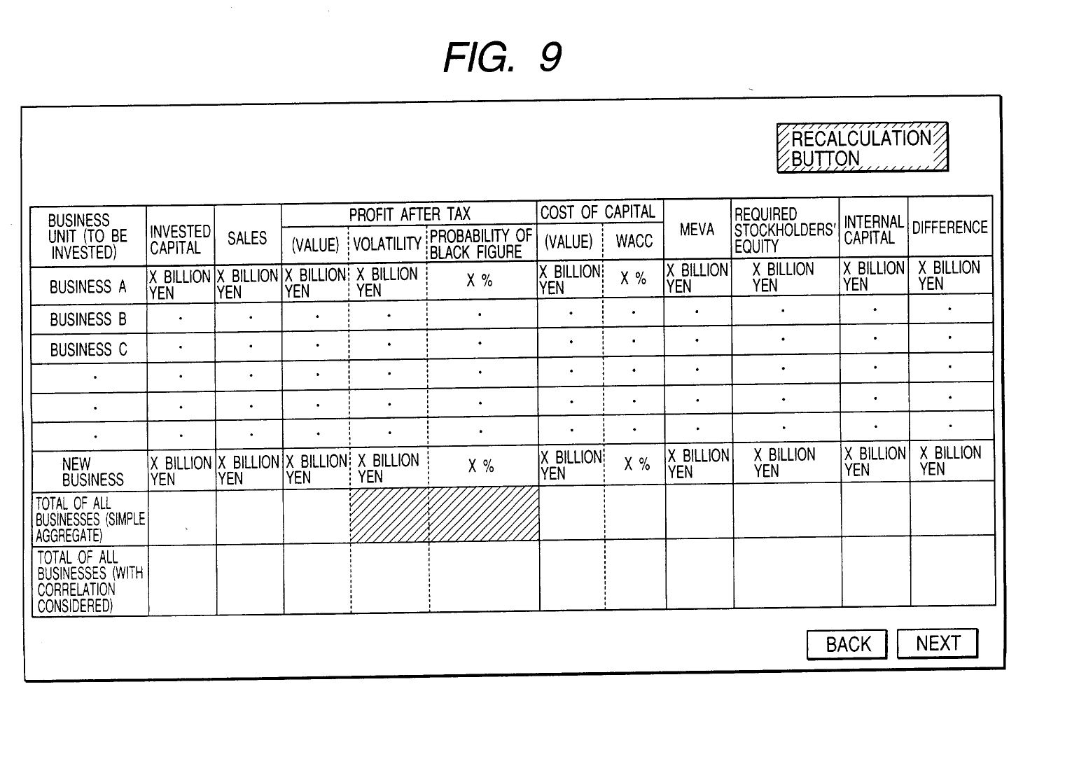

In the screen as shown in FIG. 8, the target rating moves horizontally to the right or left accordingly across it when the rating of “A,” “BBB,” or the like or the default probability of 0.01% or the like is entered, or selected from the rating/default probability table shown in the screen. In addition, clicking different parts of the screen as shown in FIG. 8 will display different numeric values as detailed in the following. Namely, clicking stockholders' equity will show “Stockholders' equity: X billion yen.” Clicking profit after tax (expected) will show “Profit after tax (expected): X billion yen.” Clicking one value of standard deviation will show “1σ: X billion yen.” Clicking probability of profit after tax being in the positive will show “Probability of profit after tax being in the positive: X%.” Clicking [Back] in the display screen shown in FIG. 8 will cause the screen shown in FIG. 7 to reappear. Clicking [Next] in the screen shown in FIG. 8 will show the screen shown in FIG. 9.

FIG. 9 is a typical screen that displays a list of major financial statements figures (invested capital, sales, net operating profit after tax, cost of capital, MEVA, stockholders' equity, internal capital, and the difference in capital) of each business or all businesses. The recalculation button provided on the display screen of FIG. 9 is used to change the financial statements figures in the screen or to recalculate the figures before and after correlation of all businesses are taken into consideration after figures involved with a new business have been entered.

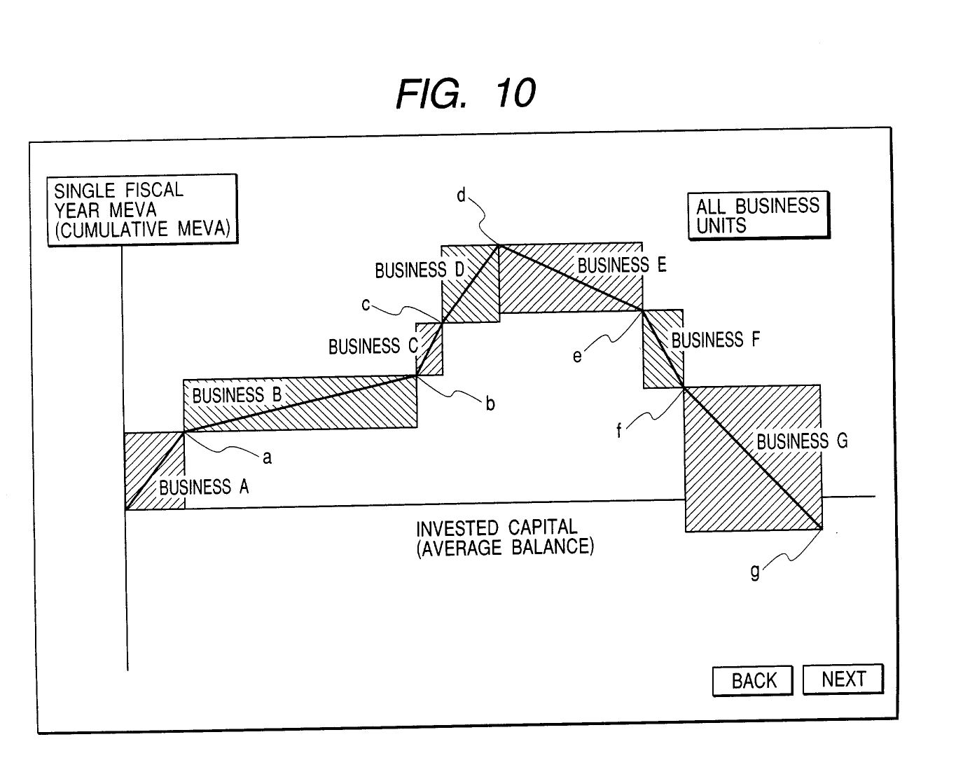

The screen shown in FIG. 9 not only facilitates a comparative examination of each individual business, but also is used to determine how a new business, when it is carried out, affects figures of all other businesses. Clicking [Back] in the display screen shown in FIG. 9 will cause the screen shown in FIG. 8 to reappear. Clicking [Next] in the screen shown in FIG. 9 will show the screen shown in FIG. 10.

FIG. 10 is a diagram that shows a typical screen displaying, in a graph, the relationship between the MEVA and invested capital (debt+equity) according to the business unit (to be invested). It covers all business units to show the relationship between MEVA and invested capital. Although the display screen shown in FIG. 10 covers all business units, it is possible to selectively set a specific business unit by dropping down the box for the business unit.

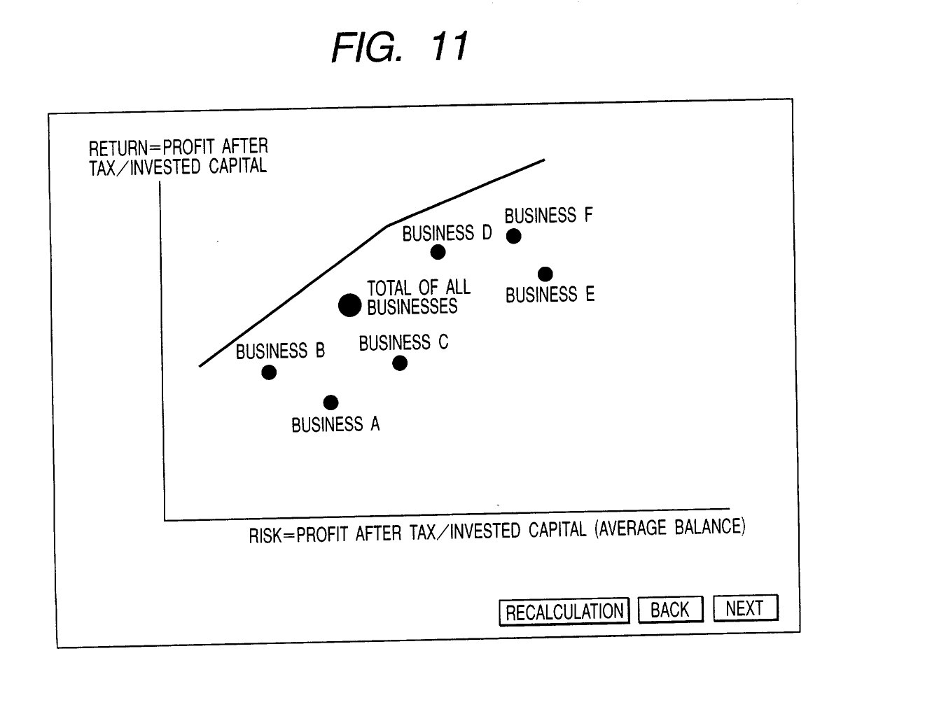

Referring to FIG. 10, for the invested capital given on the horizontal axis, that of all businesses up to business G is equivalent to the total invested capital of the enterprise. The vertical axis, on the other hand, represents the MEVA of a single fiscal year (or the cumulative MEVA). Point a depicts the invested capital and MEVA involved with business A and point b depicts the invested capital and MEVA involved with business B in relation to point a set up as the reference point. Following this procedure, point c represents the invested capital and MEVA involved with business C and point d represents those involved with business D. With business E, since the MEVA value thereof is negative, point e is located downwardly on the right of point d. Likewise, when considering businesses F and G, the MEVA of the entire enterprise is negative. That is, FIG. 10 tells that, while each of the businesses A, B, C, and D works to increase the MEVA of the entire enterprise, each of the businesses E, F, and G works to decrease the MEVA of the entire enterprise. Moving the cursor to each of the different businesses on the graph will display “MEVA xx billion yen (ratio to the total of all MEVA values) and invested capital xx billion yen (ratio to the total of all invested capitals)” of that particular business. Further, double-clicking a specific business will display the MEVA and other values of that particular business in the format shown in FIGS. 6, 7, and 8. Clicking [Back] in the display screen shown in FIG. 10 will cause the screen shown in FIG. 9 to reappear. Clicking [Next] in the screen shown in FIG. 10 will show the screen shown in FIG. 11.

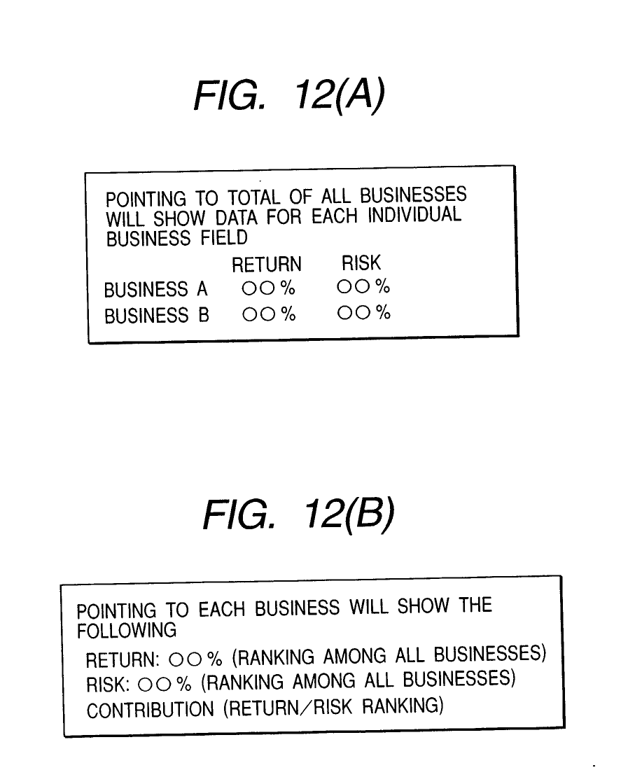

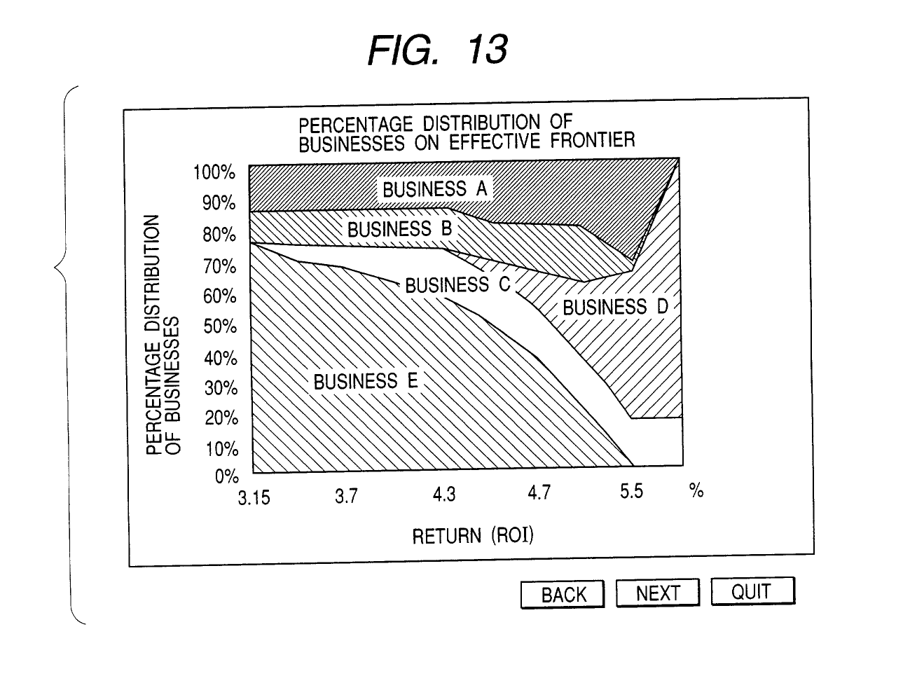

FIG. 11 is a diagram that shows a typical screen displaying risk and return values of each business and the entire enterprise. The display screen also shows a composition of different businesses that realizes an expected return with the minimum risk (an effective frontier) as selected from among the existing businesses. In the display screen shown in FIG. 11, pointing to total of all businesses will display data (return: XX%; risk: XX%) for each individual business field as shown in FIG. 12A. Clicking each business in the display screen shown in FIG. 11 will jump to the display screen shown in FIGS. 6 and 7 for the specific business. Further, pointing to each business will display “return: XX% (ranking among all businesses); risk: XX% (ranking among all businesses); and contribution (return/risk ranking)” as shown in FIG. 12B. To recalculate the total of all businesses and the effective frontier after the number of the businesses shown in FIG. 9 has been increased or decreased (by abandoning an existing business being carried out or starting a new one), the [Recalculation] button is clicked. Furthermore, pointing to the effective frontier curve in the display screen as shown in FIG. 11 will display the percentage distribution of businesses shown in FIG. 13.

FIG. 13 is a diagram that shows a typical screen displaying percentage distribution of businesses on the effective frontier. The horizontal axis represents values of the return (ROI) and the graph shows changing percentage distributions of businesses with varying return values. Specifically, pointing to the effective frontier curve on the display screen shown in FIG. 11 will display a graph showing the percentage distributions of businesses on the effective frontier as shown in FIG. 13. In the percentage distributions of businesses shown in the display screen as shown in FIG. 13, taking a specific return value on the horizontal axis (for example, a return value of 3.7%) provides the specific percentage distributions of different businesses as detailed in the following. Namely, business A is 15%, business B is 10%, business C is 5%, business E is 70%, and business D is 0%. Taking another specific return value on the horizontal axis (for example, a return value of 4.7%) provides the specific percentage distributions of different businesses as follows: namely, business A is 20%, business B is 15%, business C is 15%, business E is 40%, and business D is 10%. This means that selecting a specific return value will give specific percentage distributions of different businesses that allow to stably achieve a target. Clicking [Back] in the display screen shown in FIG. 13 will cause the screen shown in FIG. 11 to reappear. Clicking [Quit] in the screen shown in FIG. 13 will close the screen shown in FIG. 13, causing the initial screen shown in FIG. 6 to reappear.

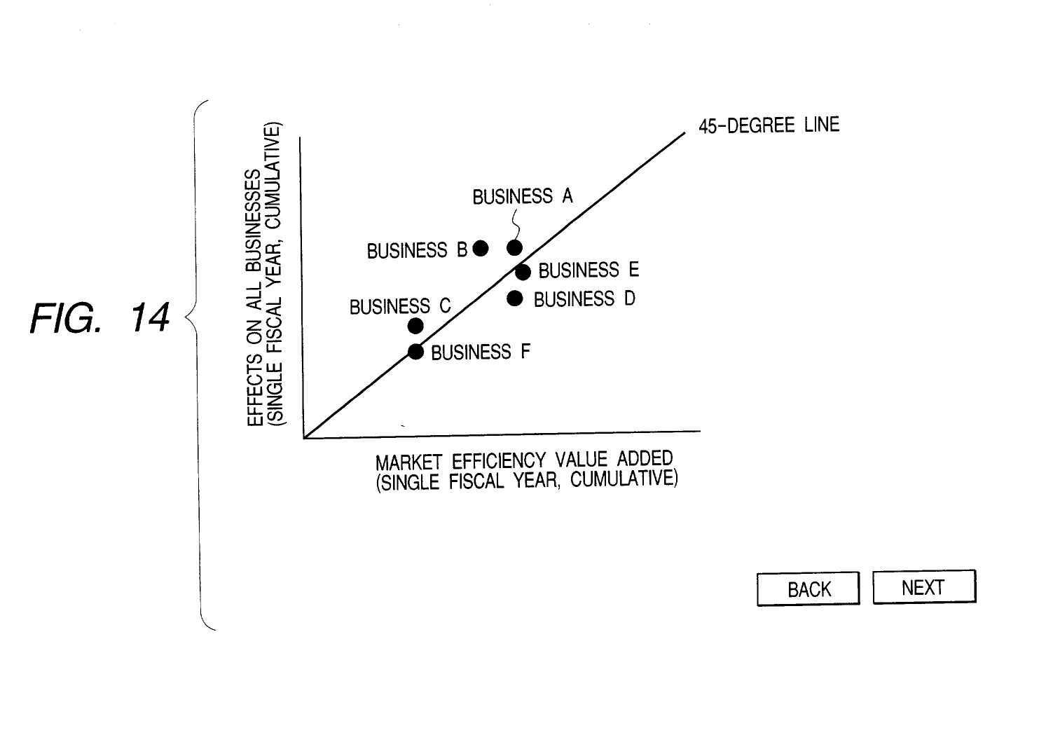

FIG. 14 is a diagram that shows a typical screen displaying MEVA of each business and an effect of the business in question on the MEVA value of the entire enterprise (increased or decreased effect of MEVA). Specifically, the balance in the MEVA value of the entire enterprise between that including the business in question and that excluding the same is obtained to determine contribution of the business concerned. This serves as a reference when starting a new business and considering the effect of the new business on the existing businesses.

In the display screen as shown in FIG. 14, the horizontal axis represents the MEVA of each business, while the vertical axis represents the effect on all businesses (Marginal Accumulated Discounted-MEVA, or MAD-MEVA). The screen shows this relationship for each business. The effect on all businesses (Marginal Accumulated Discounted-MEVA, or MAD-MEVA) means the degree of how much the addition of the business in question to the business portfolio increases the cumulative discounted value of the MEVA of the business portfolio. If the point of a specific business is located above the 45-degree line, it is known that the specific business in question contributes to the business value of the entire enterprise more than the value of the specific business. If the point of a specific business is located below the 45-degree line, on the other hand, it is known that the business value of the entire enterprise does not increase so much as the MEVA of the specific business in question. For an enterprise-wide business portfolio management, therefore, the display serves as a reference for making a decision that ensures even more efficient business operations, while taking into consideration diversification effect and synergy effect. Clicking [Back] in the display screen shown in FIG. 14 will cause the screen shown in FIG. 13 to reappear.

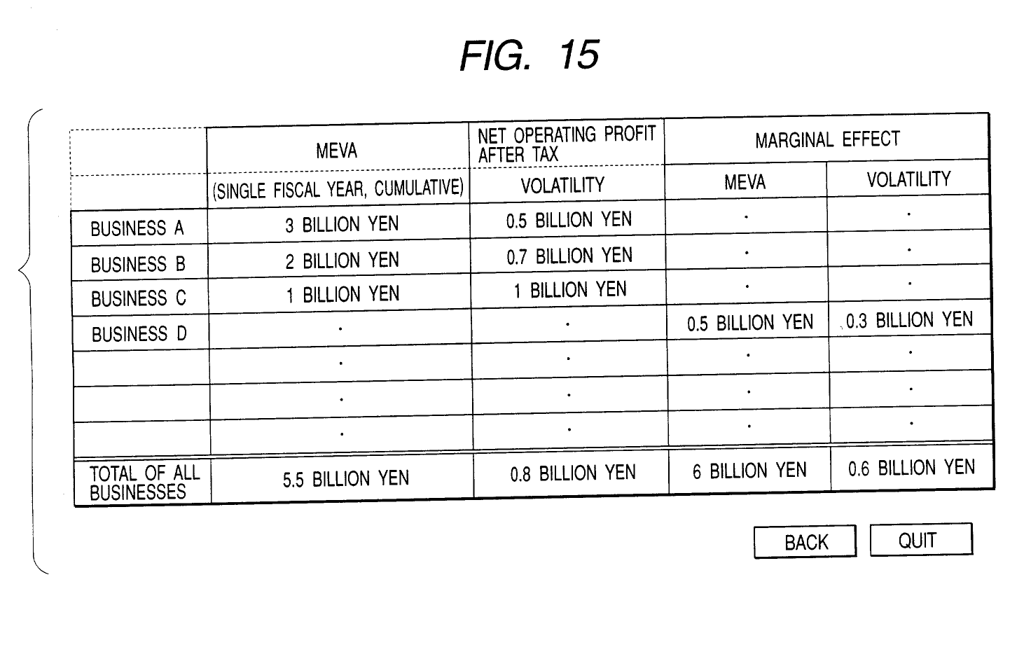

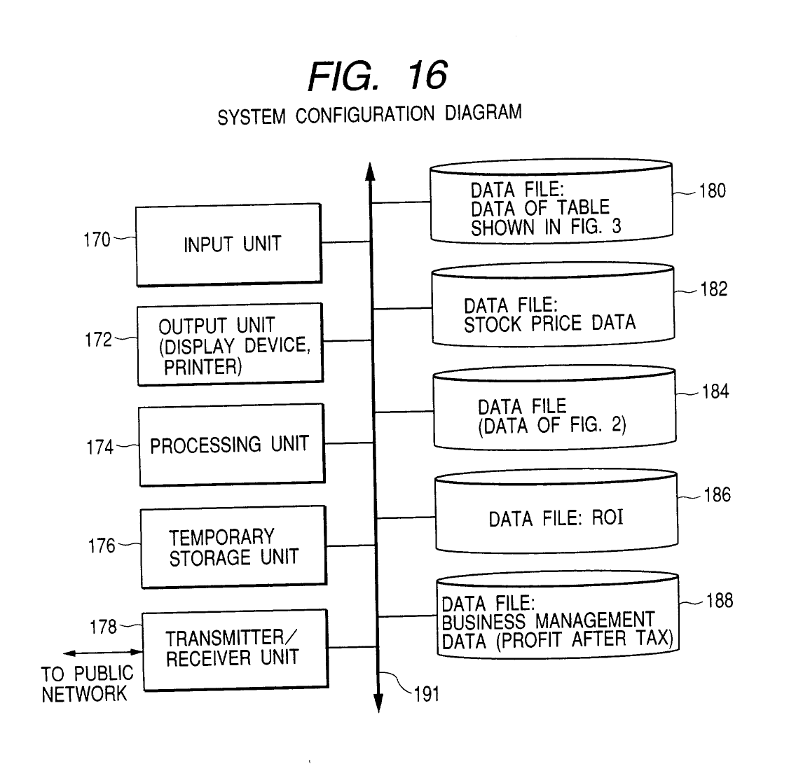

FIG. 15 is a diagram that shows a typical screen displaying, in a table, an accumulated discounted value of MEVA of each business and an effect (marginal accumulated discounted value) of the business in question on the entire enterprise, that is Marginal Accumulated Discounted-MEVA or MAD-MEVA, shown in FIG. 14. Preparing an at-a-glance table facilitates a comparative analysis between different pairs of businesses. It serves as a primary source of decision-making for building an even more efficient business portfolio.

There are embodiments of the present invention as will be described below.

FIG. 6 as explained previously shows the graph which is displayed on a display so as to illustrate the progress of the actual result value, and the reexamination plan value of MEVA. In FIG. 6, if a numerical value representing other management states, for example, a numerical value representing of balance sheet (state of property and a debt, and capital) or cash flow, could be displayed on the display, such would be of great help to a manager.

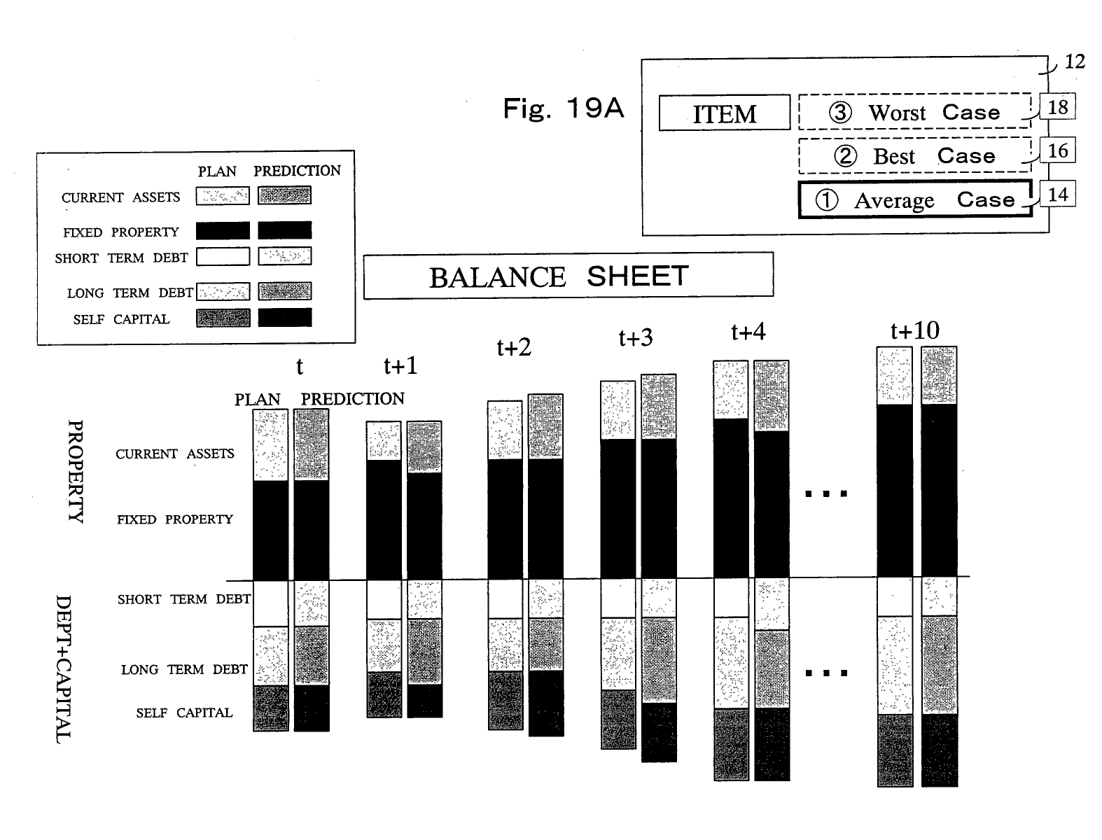

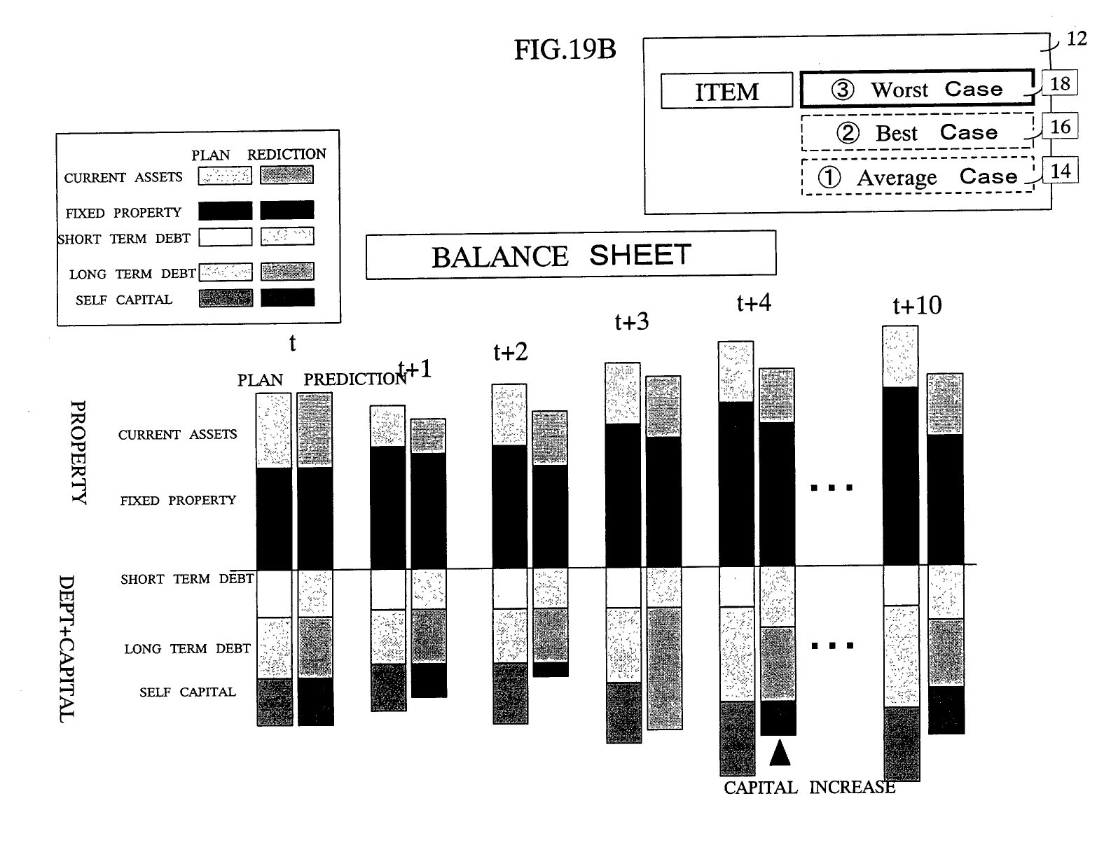

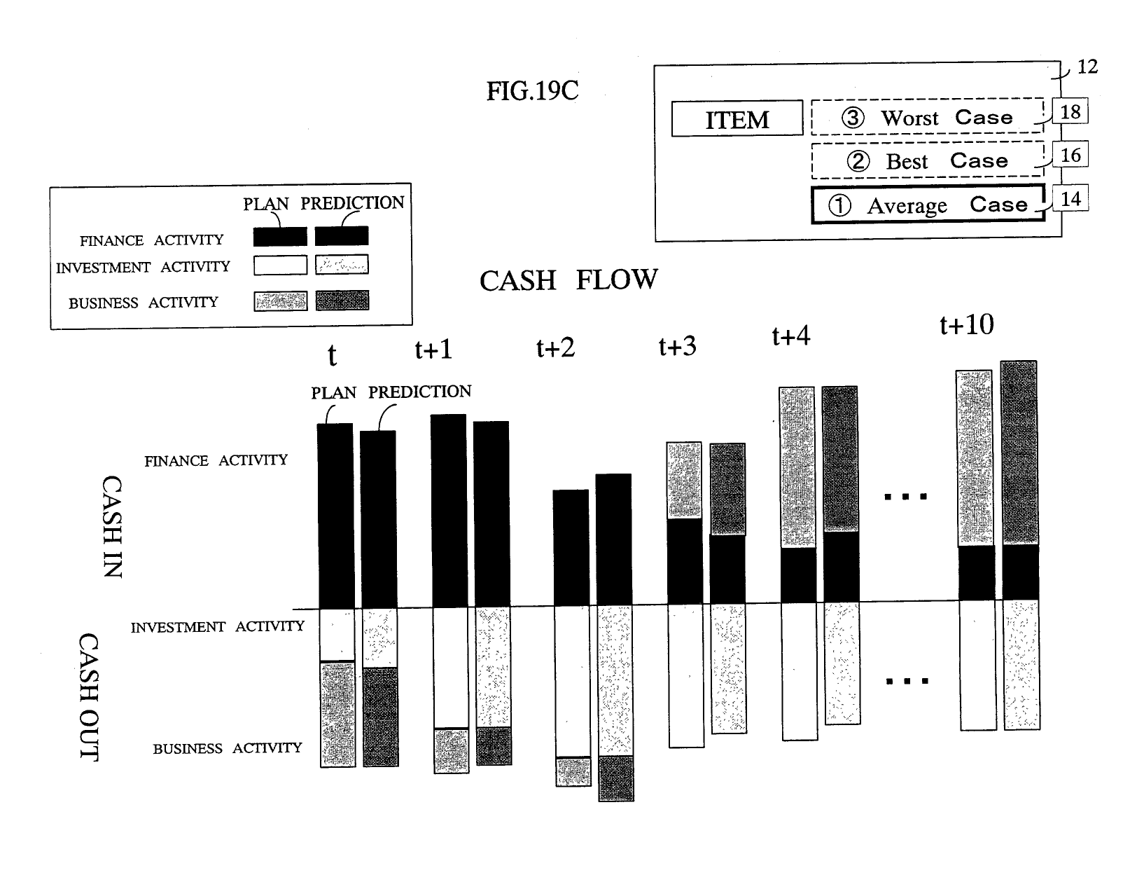

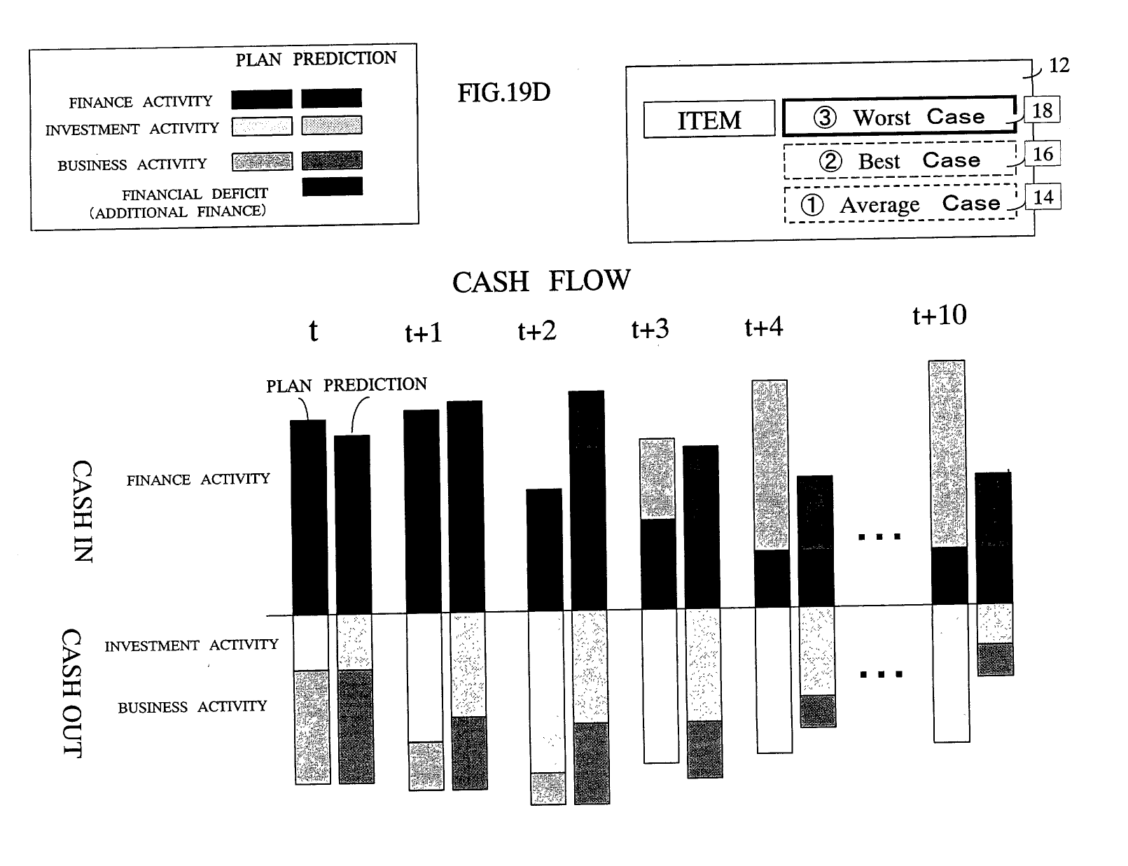

According to FIG. 6, if the contents of a display is changed by selecting a change button etc., the contents of the display will change to the graph of the data chosen from the graph of the MEVA currently displayed in FIG. 6. For example, when a balance sheet is chosen by operation of the above-mentioned change button, the graph of the balance sheet shown in FIG. 19A or FIG. 19B is displayed on the display. Moreover, if cash flow is chosen as a change of the graph of the MEVA, then the graph of the cash flow shown in FIG. 19C or FIG. 19D will be displayed on the display.

FIG. 19A is a graph of the average case of the range of fluctuation when predicting the future of the state of the selected property for every enterprise fiscal year and the selected debt, and capital.

FIG. 19B is a graph of the worst case of fluctuation when predicting the future of the state of the selected property for every enterprise fiscal year and the selected debt, and capital. The graph of FIG. 19B shows the state of the prediction value of the cash flow for every fiscal year of the selected enterprise.

FIG. 19C is a graph of the average case of fluctuation when predicting the state of the cash flow for every fiscal year of the selected enterprise in consideration of the range of fluctuation.

FIG. 19D is a graph of the worst case of the ranges of fluctuation when predicting the state of the cash flow for every fiscal year of the selected enterprise in consideration of the range of fluctuation.

In the display screen shown in FIG. 19A, t, t+1, t+2,—t+10 are the prediction values corresponding to the 3rd term, the 4th term, the 5th term,—7th term of FIG. 6. The contents of the property in each of these terms or {debt+capital} can be displayed on the display as a prediction result. In addition, although the first term of FIG. 6 and the second term correspond to t−2 and t−1, they are not displayed in FIGS. 19A-D nor FIG. 20. Since the time-axis displayed by operation of moving the time-axis of a graph, t−2 and t−1 can be displayed in FIGS. 19A-D or FIG. 20 if desired.

Since a changed part joins future prediction, deflection width exists in the prediction value by which the simulation was carried out. When the portion of the good state of the domain of deflection width was chosen and it was shown in graph, and when the portion of a bad state is chosen, in the case where an average domain is chosen, the numerical values of a prediction value differ and the graph displayed differs.

In the display shown in FIGS. 19A-D or FIG. 20, the operation area 12 has the function which allows for selection of the best case of the domain of the above-mentioned deflection width, the worst case of the above-mentioned deflection width, and the average case of the above-mentioned deflection width. Moreover, the present display displays the state of a prediction value at various states, i.e., the state of the prediction value at best case, worst case, and average case. As per FIG. 19A and FIG. 19C since \mathring{1}Average Case 14 is chosen, displaying the graph of the average value of the deflection width of a simulation result is shown. As per FIG. 19B or FIG. 19D Instead of \mathring{1}Average Case 14, \mathring{3}Worst Case 18 is selected. Thus, the display displays the graph based on the numerical value of the worst case of the domain of the above-mentioned deflection width. If \mathring{2}BEST Case 16 is chosen, the graph based on the numerical value of the best case of the domain of the above-mentioned deflection width is displayed.

FIG. 20 is a flow chart of the operation of the system according to the present invention. According to the flowchart MEVA, balance sheet, and cash flow are calculated (Steps 22-26), and held in memory. Next, when the contents which should be displayed on a display are chosen (for example, if the data of the data of FIG. 6, the data of FIGS. 19A/B, or FIGS. 19C/D is chosen) (Step 28), selected data will be read and will be indicated by a graph (Step 30). At this time, the graph in \mathring{1}Average Case is displayed as a typical display. For example, the graph of FIG. 19A or FIG. 19C is displayed. If the selection button 12 for a display is selected (Step 32) and the \mathring{2}Best Case (Step 36) or the \mathring{3} Worst Case (Step 38) are further selected, the graph in the selected mode will be expressed as best case data (Step 42) or worst case data (Step 44). Moreover, if the \mathring{1}Average Case is further selected after selection of selection button 12 (Step 34), then the graph in the selected mode will be expressed as average case data (Step 40). These mode selections are performed by selecting selection buttons 14, 16, and 18 of the selection button 12 of above-mentioned FIGS. 19A-D.

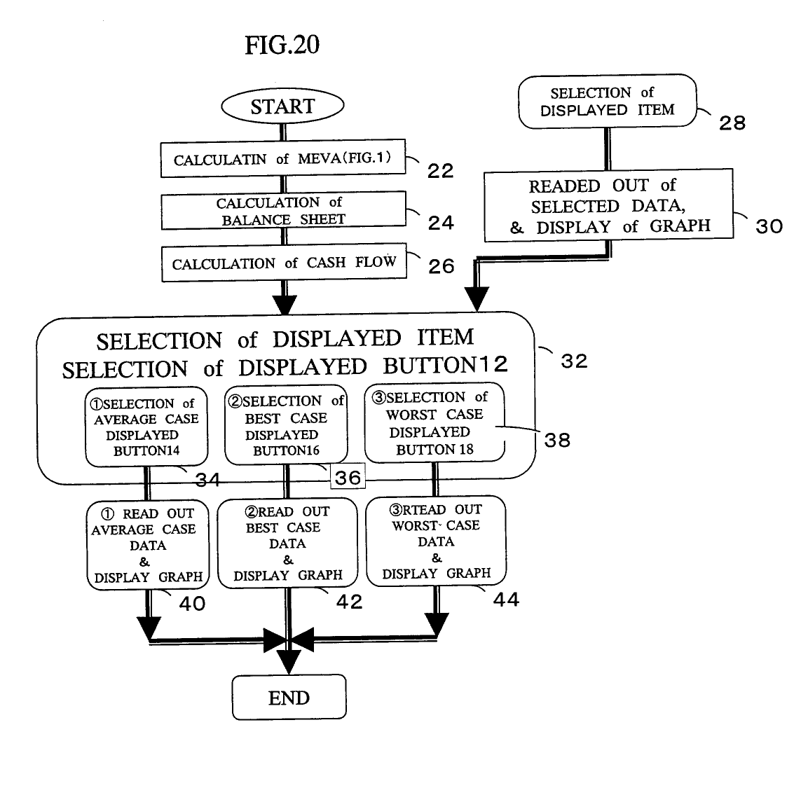

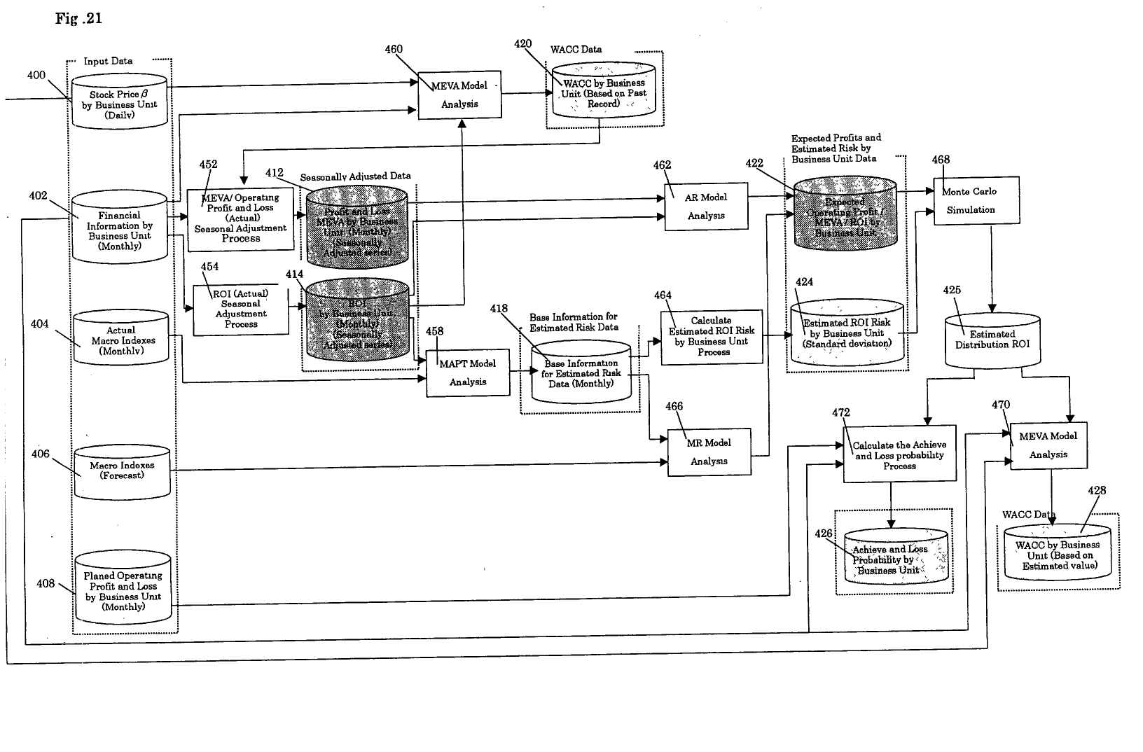

FIG. 21 is a system flowchart showing monthly performance and risk by business units. The objectives are to manage the business portfolio and to issue an alarm as needed. Input data are as follows.

Step 400 Database of Stock Price β by business unit.

Step 402 Database of financial information by business unit including:

Invested Capital (debt+equity)

Operating Profit

Step 404 Database of actual macro indexes.

Step 406 Database of forecasted macro indexes.

Step 408 Database of planed profit by business unit.

Each of the above noted steps are represented by databases in FIG. 20.

Step 454 seasonally adjusts monthly ROT (Operating Profit/Invested Capital) by business unit in Step 402 and the seasonally adjusted data are stored in Step 414. The stored data includes:

Trend-cycle series (TC)

Seasonally adjusted series (TC+I).

Step 460 corresponds with FIG. 1. The process of Step 460 calculates WACC by business units. This process uses business risk (ROT distribution) that is calculated with the trend-cycle series of ROT in Step 414. And it stores calculated WACC by business unit in Step 420. (See the explanation for FIG. 1 for more detail).

Step 452 seasonally adjusts monthly MEVA (=Operating Profit−WACC×Invested Capital) and operating profit by business units. This process uses WACC in Step 420 and invested capital and operating profit by business units in Step 402 and stores each trend-cycle series into Step 412.

Step 458 uses MAPT analysis (depended variable: actual ROI, explanatory variable: fluctuations of macro index) and calculates each macro indexes exposure and specific ROT (not explained by macro indexes) by business units. This step uses the seasonally adjusted series of ROT (TC+I) in DB414 and actual macro indexes in DB404. This process calculates:

Xⱼ and α+eᵢ.(ROI)ᵢ=X₁F₁ᵢ+X₂·F₂ᵢ+ . . . +Xₙ·Fₙᵢ+α+eᵢ

where (ROI)I is seasonally adjusted ROI at time i, Fⱼᵢ is fluctuation in actual j macro index at time i, Xⱼ is j macro index exposure and α+eᵢ is Specific ROI

This process also calculates the covariance matrix among the macro indexes:

COVᵢⱼ=COV(Fᵢ, Fⱼ)

where COVᵢⱼ is (i, j)-component of covariance matrix, COV(Fᵢ, Fⱼ) is covariance between fluctuations of i macro index and j macro index.

The above calculated values are stored in Step 418 as “Base Information for Estimated Risk Data”.

Step 462 uses AR analysis and estimates the expected operating profit and the expected MEVA and the expected ROI by business unit. This process uses operating profit, MEVA and trend-cycle of actual operating profit in DB412, and trend-cycle of actual ROI in DB414. The estimated value is stored in DB422.

Step 464 calculates the estimated ROI risk by business units using the “Base Information for Estimated Risk Data”. Calculation method is as follows:

Var(ROI)=X₁·X₁·Var(Fₙ)+ . . . +Xₙ·Xₙ·Var(Fₙ)+2·X₁·X₂·COV(F₁·F₂)+ . . . +2·Xₙ₋₁·Xₙ·COV(Fₙ₋₁·Fₙ)+Var(α+ei)

where Var(Fi) is variance of fluctuations in i macro index, Var(α+ej) is variance of Specific ROI. The estimated value is stored in Step 424.

Step 466 estimates expected ROI using MR analysis. This step uses each macro indexes exposure by business unit in DB418 and forecast of each macro indexes in Step 406. The value is calculated as follows:

Expected ROI=X₁·F₁+X₂·F₂+ . . . +Xₙ·Fₙ+α

where Fⱼ is forecasted fluctuation in j macro index. The estimated value is stored in Step 422.

Step 468 calculates the estimated ROI distribution using Monte Carlo simulation. This step uses the estimated ROI risk in Step 424 and the expected ROI, the expected operating profit and the expected MEVA in Step 422. Estimated ROI distribution is stored in Step 425.

Step 470 corresponds with FIG. 1. This step calculates WACC by business unit using estimated ROI distribution in Step 425. (See the explanation for FIG. 1 for more detail)

Step 472 calculates the achieve probability and the loss probability. This step uses the planed operating profit and loss by business unit in Step 408 and invested capital by business unit in Step 402. Calculated values are stored in Step 426. The achieve probability means the probability that profit surpasses a threshold.

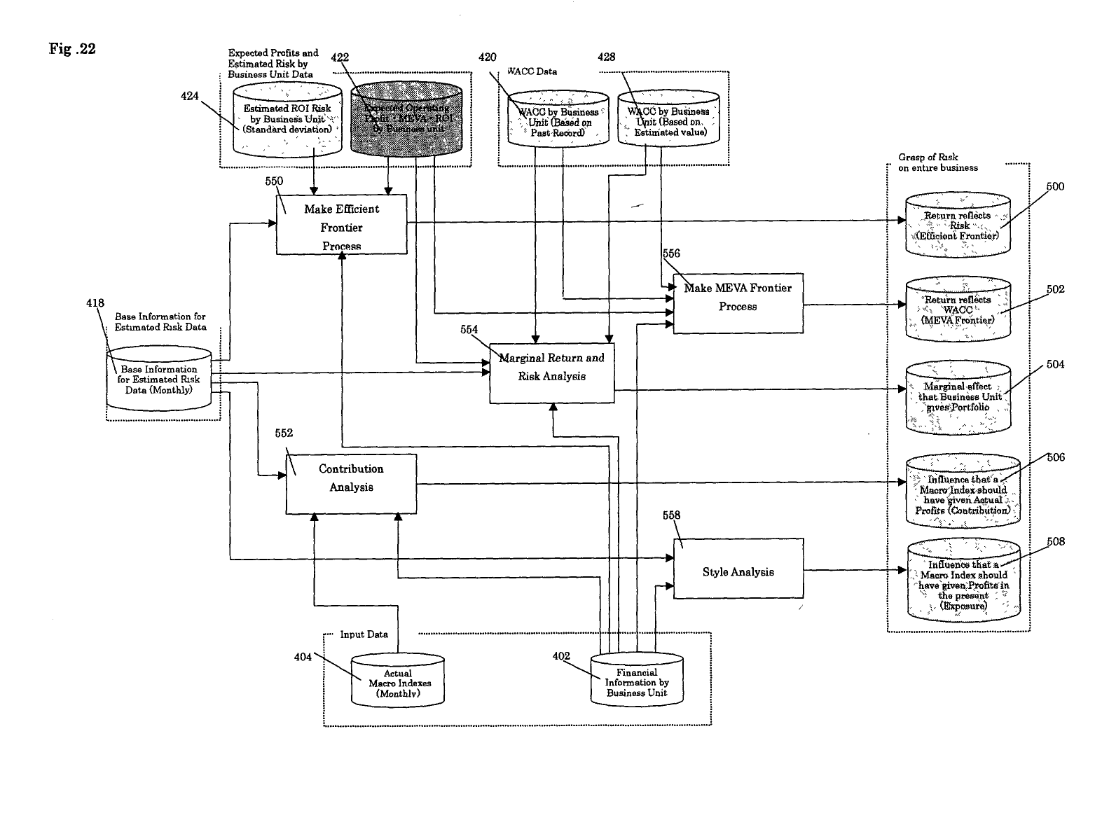

FIG. 22 is a system flowchart showing monthly performance and risk on the entire business. The objects are to manage the business portfolio and issue an alarm when needed. Input data are as follows:

Step 402 Database of financial information by business unit

Step 404 Database of actual Macro Indexes.

Step 418 Database of Base Information for Estimated Risk Data (Monthly)

Step 422 Database of Expected operation profit and MEVA and ROI by business units.

Step 420 WACC by business unit (based on past record)

Step 428 WACC by business unit (based on estimated value)

Step 424 Estimated ROT risk by business units (standard deviation)

Each of the above noted steps are represented by databases in FIG. 21.

Step 550 makes efficient frontier with expected ROT and estimated ROT risk. This step uses expected ROT by business unit in DB418 and Base Information for Estimated Risk Data in Step 418. This step also uses estimated ROT risk by business unit in Step 424 and invested capital by business unit in Step 406, and draws the present business portfolio position and each business unit position in a graph. The point of efficient frontier (expected ROT and estimated ROT risk's plot) and the point of present business portfolio position and the point of business unit position are stored in Step 500.

Step 552 calculates influence that a macro index has on actual ROT (or profit) of the entire business. This step uses each macro indexes exposure by business unit in Step 418, actual macro indexes in Step 404 and invested capital by business unit in Step 406. Each macro indexes exposure by business units and contribution value (=macro index exposure×fluctuations of macro index) are stored in Step 506 monthly.

Step 554 calculates marginal influence that each business has on the business portfolio (marginal MEVA). This step uses actual operating profit and invested capital by business units in Step 402, WACC based on past record in Step 420, WACC based on estimated value in Step 428, expected operating profit and expected MEVA in Step 422. Calculated value is stored in Step 504. (See the explanation of FIG. 32 for more detail).

Step 556 makes MEVA Frontier. This step uses WACC based on past record in Step 420, WACC based on estimated value in Step 428, expected ROT by business unit in Step 422 and actual ROT by business unit in Step 402. Calculated value is stored in Step 502. (See the explanation of FIG. 28 for more detail).

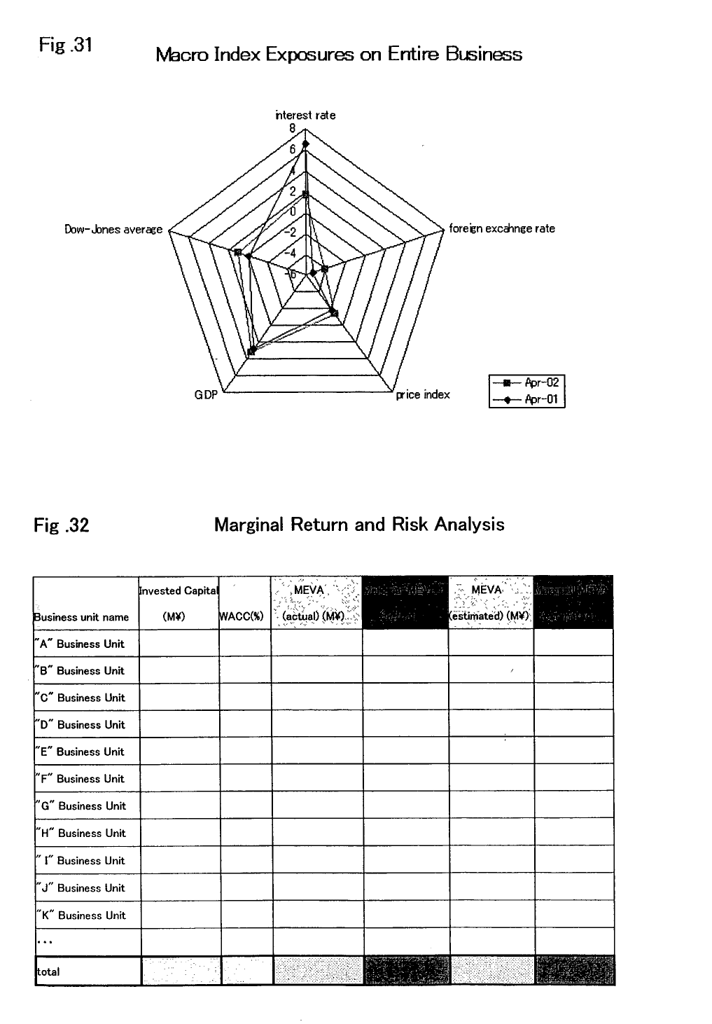

Step 558 analyzes style of business portfolio. This process uses each macro indexes exposure by business unit in Step 418 and invested capital by business unit in Step 402. Calculated value is stored in Step 508. (See the explanation of FIGS. 30 and 31 for more detail).

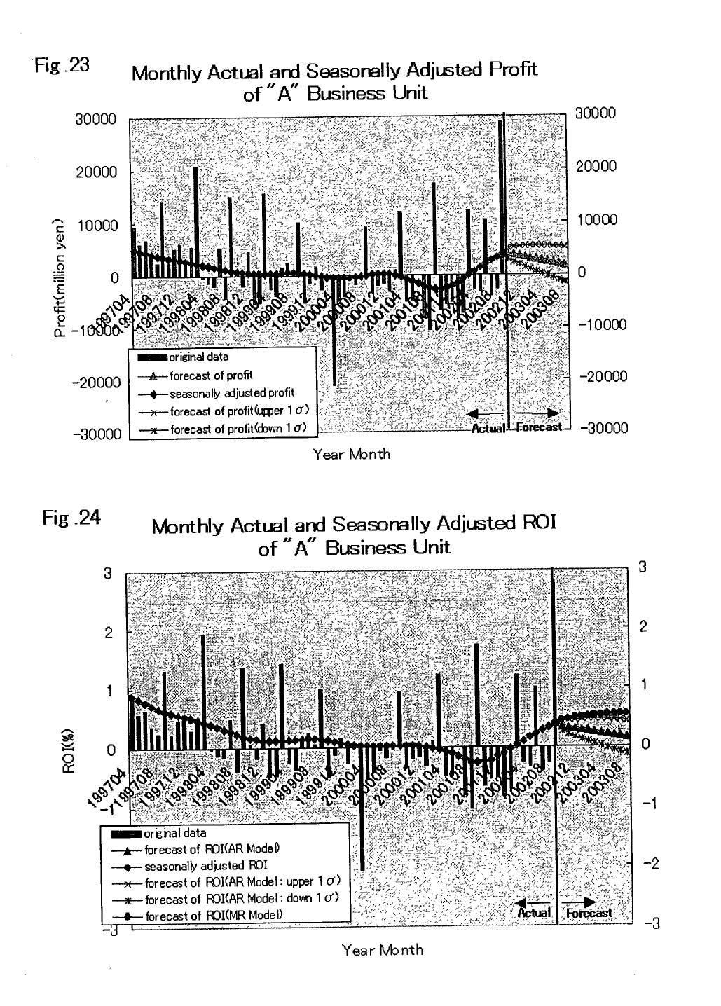

FIG. 23 shows a line graph and a bar graph. In this graph, the horizontal axis is Year/Month, the vertical axis is operating profit. A bar graph is monthly operating profit of “A” business unit. A line graph is seasonally adjusted operating profit of “A” business unit. Input data is actual operating profit in DB402 of FIG. 21 and trend-cycle of operating profit (TC) in Step 412 of FIG. 21. A line graph (trend-cycle of operating profit) contributes to see trend of operating profit for long term because actual operating profit usually has big fluctuations. This graph also contains expected operating profit and its risk that is estimated by AR Analysis in Step 422. So it is possible to see the fluctuations of operating profit in the future.

FIG. 24 shows a line graph and a bar graph. In this graph, the horizontal axis is Year/Month, and the vertical axis is ROI (%). A bar graph is monthly actual ROI. A line graph is a trend-cycle of actual ROI. Input data is actual ROI (=Operating Profit/Invested Capital) in Step 402 of FIG. 21 and trend-cycle of ROI (TC) in Step 414 of FIG. 21. A line graph (trend-cycle of ROT) contributes to see the trend of ROT for long term because actual ROI usually has big fluctuations. This graph also contains expected ROI and its risk is estimated by AR Analysis and MR Analysis in Step 422. So it is possible to see the fluctuations of ROT in the future and to compare different estimated method: AR analysis and MR analysis.

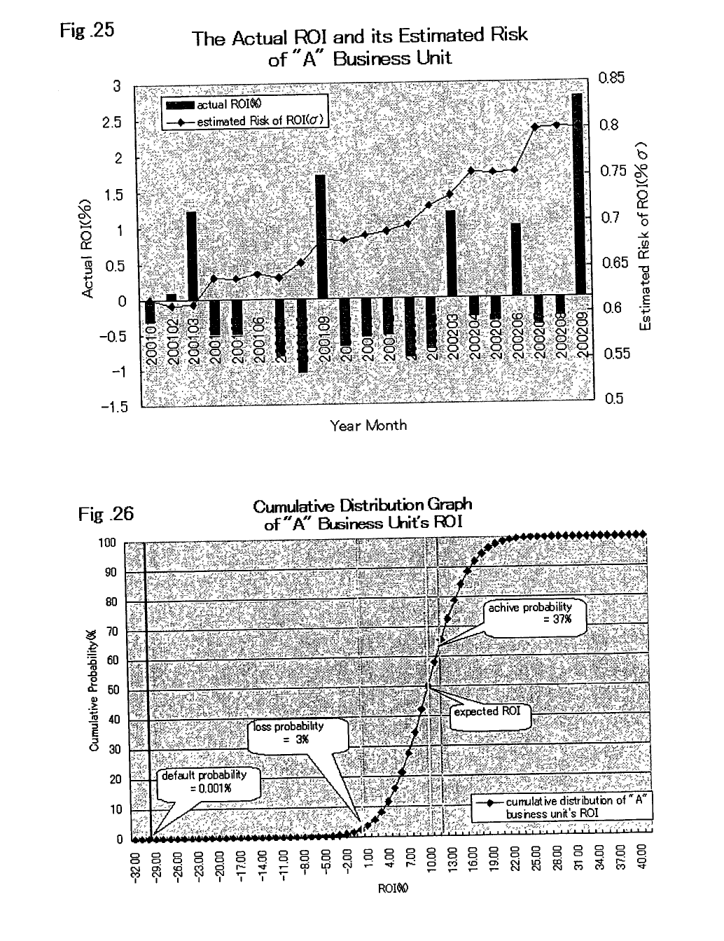

FIG. 25 shows a line graph and a bar graph. In this graph, the horizontal axis is Year/Month, the left vertical axis is actual ROT (%), and the right vertical axis is estimated ROT risk (standard deviation %). A bar graph is monthly actual ROT. A line graph is estimated ROT risk. Input data is actual ROI (=Operating Profit/Invested Capital) in Step 402 of FIG. 21 and estimated ROT risk by business unit in Step 424 of FIG. 21. Estimated risk gain and loss is compared to actual ROT in this graph. It makes possible to check an estimated risk and to take the pre-action for mounting estimated risk.

FIG. 26 shows a line graph and points of three probabilities. In this graph, the horizontal axis is ROT (%) and the vertical axis is cumulative probability (%). A line graph is cumulative distribution graph of “A” business unit's ROI. Three points are achieve probability, default probability and loss probability. Input data are the achieve probability and the loss probability by business horizontal axis is Year Month. Input data is contribution data in Step 506 of FIG. 22. This graph gives important indicator on past analysis that how large fluctuations in macro index should have contributed fluctuations in ROI on the entire business.

FIG. 30 is a graph showing a bubble chart. In this graph, the vertical axis is “A” macro index exposure, the horizontal axis is “B” macro index exposure, and the bubble size is invested capital. Input data is exposure data in Step 508 of FIG. 22. It makes possible the present analysis of the business portfolio style: macro index exposure by business unit and invested capital in one graph.

FIG. 31 is graph showing a radar chart. In this graph, items are macro index's names and values are macro index exposures. This graph has two radar lines at different time point. Input data is exposure data in Step 508 of FIG. 22. It is possible to get a grasp of style of different time by comparing between different point's macro index exposures in this graph.

FIG. 32 is a table showing MEVA based on past record, MEVA based on forecast of operating profit and marginal influence that business unit gives portfolio. Input data is DB504 of FIG. 22. This table contributes to compare different business unit, because it is on the same table. And it is possible to get information for purpose of unit in Step 426 of FIG. 21. So as to illustrate the various risks possible at any time, this graph contains various probabilities.

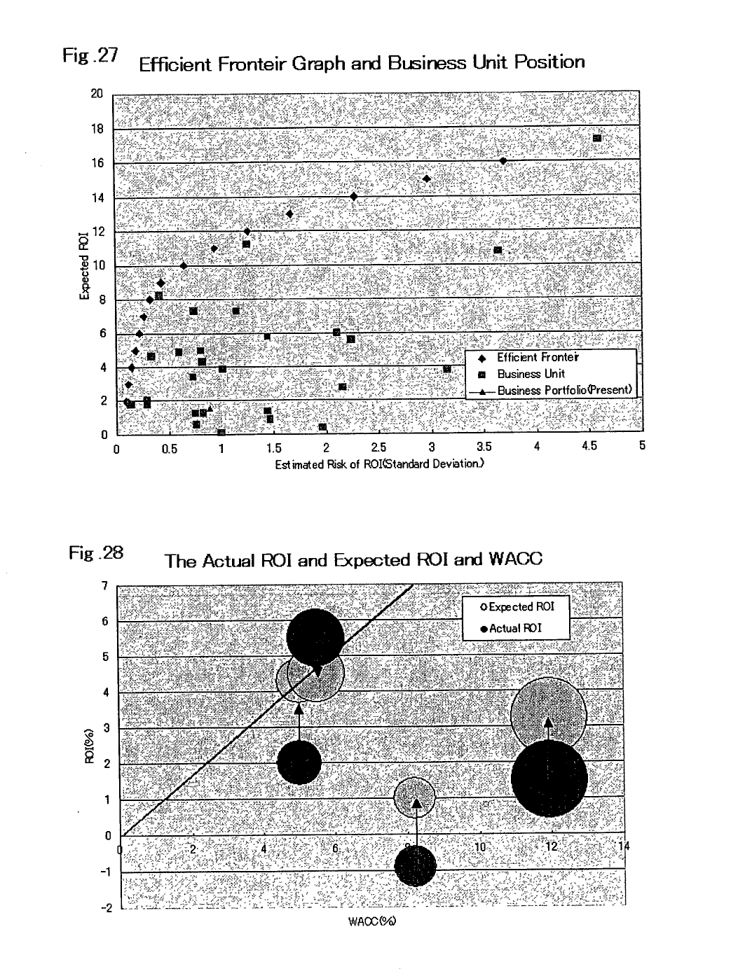

FIG. 27 is a graph showing efficient frontier of business portfolio's ROI. In this graph, the horizontal axis is estimated risk of ROI (standard deviation %) and the vertical axis is expected ROI (%). Input data is efficient frontier data in Step 500 of FIG. 22. This graph is an indicator of the business portfolio rearrangement, because it is possible to compare each business unit position, present portfolio position and theoretically optimal business portfolio position in this graph.

FIG. 28 is a graph showing a bubble chart. In this graph, the horizontal axis is WACC (%), the vertical axis is ROI (%), and bubble size is invested capital. Input data is MEVA Frontier data in DB502 of FIG. 22. This graph expresses a relationship between WACC and ROI. It is possible to check on an appropriate WACC, because the expected ROI, actual ROI and WACC can be compared in this graph.

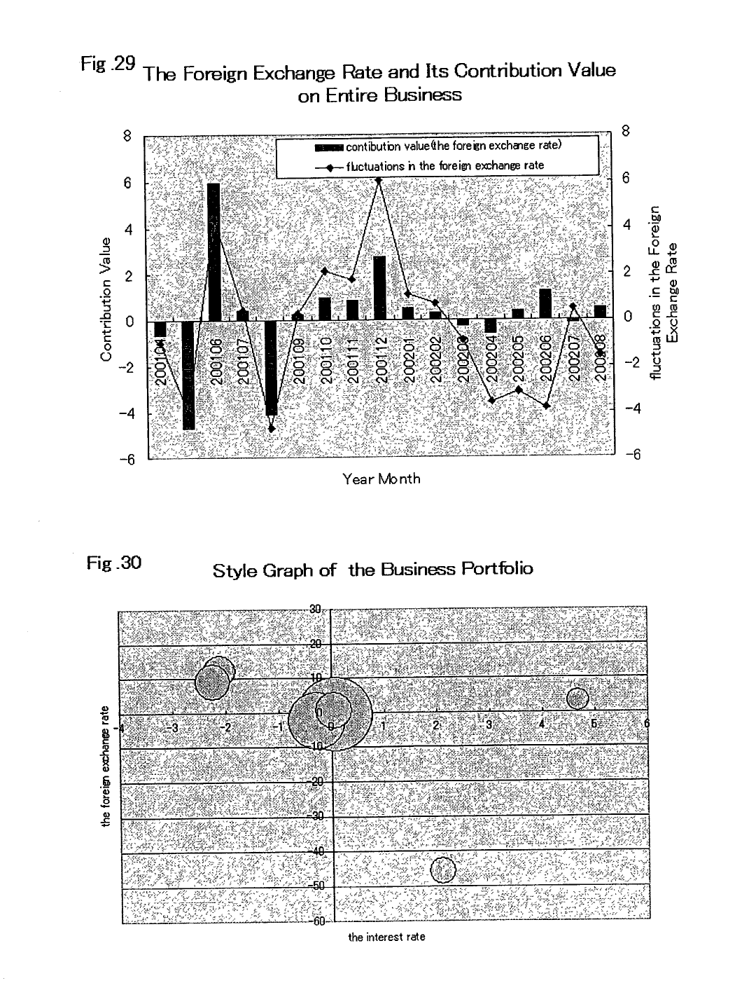

FIG. 29 shows a bar graph of contribution value (macro index exposure×fluctuations in macro index) and a line graph of fluctuations in macro index. In this graph, the left vertical axis is contribution value for ROI, the right vertical axis is fluctuations in macro index, and the constructing efficient business portfolio.

As described in the foregoing, the business performance index processing system according to the present invention can accomplish the following task. Namely, it provides business performance indices that relate to the management of performance evaluation, incorporate a risk (uncertainty) evaluation in the investment and withdrawal guidelines, appropriately create a business portfolio (selection and concentration), make the invested capital-to-debt composition (financing) appropriate, and eventually bring a sustainable growth to the company in harmony with the society.

Furthermore, according to the calculation system of the present invention, it is possible to vitalize operations within a company, determine investment or withdrawal for each business unit to concentrate on specific areas of businesses, ensure optimum corporate finance, and thereby allow the company to maintain the sustainable growth in harmony with the society.

What is claimed is:

1. A business performance index processing system, comprising:
a computer that performs calculations for obtaining, based on a probability distribution of a ratio of the value of profit to an investment amount, a capital composition (debt/equity ratio) that satisfies a predetermined default probability, a weighted average cost of capital based on the capital composition, a borrowing cost, and an equity cost, and market efficiency value added (MEVA), from the weighted average cost of capital based on a net operating profit after tax; and
a display device that, based on the results of these calculations, gives a display of data created relating to MEVA.

2. The business performance index processing system according to claim 1, wherein, the display device displays a forecast value for each of fiscal years making up an entire period subjected to calculation relating to MEVA.

3. The business performance index processing system according to claim 1, wherein, the display device displays a cumulative value of a forecast value for each of fiscal years making up an entire period subjected to calculation relating to MEVA.

4. The business performance index processing system according to claim 1, wherein, the display device displays a forecast value for each of fiscal years making up an entire period subjected to calculation relating to MEVA, and a cumulative value of the forecast value for each of fiscal years making up the entire period subjected to calculation relating to MEVA, with said forecast value compared with said cumulative value.

5. The business performance index processing system according to claim 1, wherein, the display device displays a forecast value for each of fiscal years making up an entire period subjected to calculation relating to MEVA, and a record value for each of fiscal years making up the entire period subjected to calculation relating to MEVA, with said forecast value compared with said record value.

6. The business performance index processing system according to claim 1, wherein, the display device displays a cumulative value of a forecast value for each of fiscal years making up an entire period subjected to calculation relating to MEVA, and a cumulative value of a record value for each of fiscal years making up the entire period subjected to calculation relating to MEVA, with said cumulative value of the forecast value compared with said cumulative value of the record value.

7. The business performance index processing system according to claim 1, wherein, the display device displays a plurality of business plans under way on a screen thereof relating to MEVA.

8. The business performance index processing system according to claim 1, wherein, the display device displays data relating to MEVA on a semi-annual, quarterly, or monthly basis for an entire period subjected to calculation.

9. The business performance index processing system according to claim 3, wherein, the display device displays the cumulative value relating to MEVA as discounted using a cost of capital or a risk-free rate.

10. The business performance index processing system according to claim 3, wherein, the display device displays, relating to MEVA, a forecast value for each of an invested capital, sales, a profit after tax, a weighted average cost of capital, and a MEVA for each of fiscal years making up the entire period subjected to calculation in comparison with one another, with each item compared with one another, as calculated from the calculated MEVA.

11. The business performance index processing system according to claim 10, wherein, a forecast value, a record value, and a difference between these two values, are displayed for each of the invested capital, sales, profit after tax, weighted average cost of capital, and MEVA.

12. The business performance index processing system according to claim 11, wherein, the record value displayed for each of the invested capital, sales, profit after tax, weighted average cost of capital, and MEVA is replaced, after evaluation, by a forecast value as obtained by reviewing the same based on the record value immediately near the evaluation point.

13. The business performance index processing system according to claim 1, wherein, the display device displays, relating to MEVA, in a graph a probability distribution of a net operating profit after tax based on MEVA calculated for each investment plan.

14. The business performance index processing system according to claim 1, wherein, the display device displays data relating to MEVA for each business unit or for an entire enterprise.

15. The business performance index processing system according to claim 14, wherein, the display device displays, relating to MEVA, an invested capital, sales, a profit after tax, a cost of capital, a MEVA, a stockholders' equity, an internal capital, and a difference in capital for each business, based on MEVA calculated for all businesses.

16. The business performance index processing system according to claim 15, wherein, the invested capital, the sales, the profit after tax, the cost of capital, the MEVA, the stockholders' equity, the internal capital, and the difference in capital for each business are displayed in terms of a simple addition of each of these items and an addition taken with correlation among different businesses taken into consideration, with said additions compared with each other.

17. The business performance index processing system according to claim 16, wherein, the display device displays, relating to MEVA, a graph representing the calculated MEVA in relation to an invested capital for all businesses subjected to calculation, said graph being displayed with each business item connected to each other.

18. The business performance index processing system according to claim 1, wherein, the display device displays, relating to MEVA, risk-return data calculated based on MEVA calculated for all businesses and an effective frontier induced therefrom.

19. The business performance index processing system according to claim 1, wherein, the display device displays, relating to MEVA, MEVA calculated for each business unit together with an effect (with correlation taken into consideration) of a specific business unit in question on MEVA of an entire enterprise.

20. The business performance index processing system according to claim 1, wherein, the display device displays, relating to MEVA, an accumulated discounted value of MEVA calculated for each business unit and an effect on MEVA of an entire enterprise (Marginal Accumulated Discounted-MEVA) shown in an at-a-glance table format.

21. A system for processing business performance. index using a computer, comprising:
a storage device having therein a file that stores therein information relating to credit rating and default probability, a file that stores therein information relating to stock prices, a file that stores therein information relating to a ratio of a value of profit to an invested capital (ROI), and a file that stores therein information relating to a profit after tax;
an input unit with which information to be stored in any of these files is input or a command for inputting of the information is issued;
a processing unit that performs the calculations, in relation to the information stored in these files, for obtaining a required capital composition (an optimum debt/equity ratio) of an invested capital based on a probability distribution of a return on investment, obtaining a weighted average cost of capital based on the capital composition, a borrowing cost, and an equity cost, and obtaining a market efficiency value added (MEVA) from the weighted average cost of capital and a net operating profit after tax; and
a display device that displays data created relating to MEVA based on a result of processing performed by the processing unit.

22. The business performance index processing system according to claim 21, wherein, the display device displays a forecast value for each predetermined segment of an entire period of calculation concerning MEVA or information relating to accumulation of the forecast values.
